(19) United States
(12) Patent Application Publication
(10) Pub. No.: US 2024/0037686 A1
(43) Pub. Date: Feb. 1, 2024

(54) SYSTEM FOR AND METHOD OF ELECTRONICALLY HANDLING A CASINO MARKER AND EXTENSION OF CREDIT

(71) Applicant: NRT Technologies, Inc., Las Vegas, NV (US)

(72) Inventors: Mary Ann Nicholson, Las Vegas, NV (US); Jerry Buchanan, Nashville, TN (US); Michael Dominelli, Toronto (CA); Nasr F. Sattar, Las Vegas, NV (US)

(21) Appl. No.: 18/224,658

(22) Filed: Jul. 21, 2023

Related U.S. Application Data
(60) Provisional application No. 63/391,241, filed on Jul. 21, 2022.

(51) Int. Cl. G06Q 50/34; G06Q 40/08; G07F 17/32

(52) U.S. Cl. CPC G06Q 50/34; G06Q 40/08; G07F 17/322

(57) ABSTRACT

This specification relates to a system for and method of handling electronic markers and extensions of credit for use at a gaming establishment, such as a casino. The electronic marker can be redeemed using cash or cash equivalents, casino valued currency (such as casino chips), or by electronic transfer of funds. Extensions of credit can be provided to a patron at a gaining table in real-time through communications with a mobile device. Such extensions of credit can be a courtesy extended to high level, fast betting casino patrons, for example. At the end of the gameplay, the total amount of funds extended (less any repayment by the patron at the table) can be converted to casino marker.

### CROSS-REFERENCE TO RELATED APPLICATIONS

This application claims the benefit of U.S. Ser. No. 63/391,241, filed on Jul. 21, 2022, entitled SYSTEM FOR AND METHOD OF ELECTRONICALLY HANDLING A CASINO MARKER AND EXTENSION OF CREDIT, the disclosure of which is incorporated herein by reference in its entirety.

### BACKGROUND

A marker account is a draft account similar to a counter check from a bank provided by a gaming establishment that permits an individual to continue to gamble without carrying cash. A marker account may be a debit account where the individual's funds are held in escrow by the establishment or a line of credit is extended by the casino. When a person at a gambling table requests an X-dollar marker the pit boss is called to the table. The pit boss records the person's name and then verifies the person's account status by contacting the casino cage. The cage operator compares the specified amount (X-dollars) to the available limit (available debit or credit limit) in the account. The request is then approved or declined. If the request is approved, the specified amount is deducted from the available account balance (or credit limit) and the cage operator presents the pit boss with an unsigned marker for X-dollars. Upon being signed by the requester, the marker is returned to the cage and the requester is paid in casino chips (or other wagering media) with the same total value of X-dollars. The originally signed marker, also referred to as a counter check, is typically kept at the cage or at another secure location.

There are primarily three methods for the requester to redeem or repay the marker. Firstly, the requester of the marker can provide the necessary funds to redeem the marker outright. For example, the requester can redeem the marker by providing cash or a personal check for X-dollars. Upon delivery of the requisite funds to the cage operator, the requester is given the originally signed marker. The cage operator typically retains a carbon copy of the original marker to ensure the casino has a complete record of all marker transactions. Secondly, the requester of the marker can redeem the marker by providing X-dollars in casino currency, such as casino chips. Thirdly, if the marker was based on a line of credit, the marker itself provides the requester's bank routing number and account number such that the marker can be cashed or deposited like a check. Should the requester of the marker fail to redeem the marker within a predetermined time period (typically one to two weeks), then the casino may cash the originally signed marker as a check in payment of the outstanding balance. Some casinos will send an invoice to the requester prior to cashing the marker. For example, the casino may send an invoice to the requester's residence address when the requester departs from a stay at the hotel in which the casino is located. The requester is granted a period of time, for example, thirty days, within which to pay the invoice. If the marker has not been redeemed within thirty-one days, then the marker may be cashed by the casino.

Unfortunately, the aforementioned process is cumbersome, slow and prone to error. If multiple players are requesting markers, the pit boss can service only one such player at a time. The cage operator is likewise limited. Additionally, the extensive paperwork that is generated by the current marker system places a significant burden on the gaming establishment. Redemption of markers is also a time-consuming and inconvenient process for patrons. Great care must be taken to ensure no markers or payments are lost or inappropriately issued. Theft of the original marker is also a cause for concern.

It would therefore be desirable to provide a system for handling markers which is a substantial improvement over existing marker management systems. Advantageously, such a system reduces the use of paper, reduces manpower requirements, is quicker and more secure, and minimizes errors and improves customer service.

Other electronic gaming systems are known in the prior art which have attempted to address similar problems. Unfortunately, none have proven entirely satisfactory. Reference may be had to U.S. Pat. No. 6,394,907 to Rowe (Cashless Transaction Clearinghouse); U.S. Pat. No. 6,547,131 to Foodman et al. (Preset Amount Electronic Funds Transfer System for Gaming Machines); U.S. Pat. No. 6,739,972 to Flanagan-Parks et al. (Credit System for Gaming Machines and Gaming Tables); U.S. Pat. No. 6,758,393 to Luciano et al. (Mobile Cashier Terminal); U.S. Pat. No. 6,997,807 to Weiss (Cashless Gaming System: Apparatus and Method) and the like.

### BRIEF DESCRIPTION OF THE DRAWINGS

The present disclosure will be more readily understood from a detailed description of some example embodiments taken in conjunction with the following figures:

FIG. 1 is a flow diagram of one process of handling an electronic marker.

FIG. 2 is a flow diagram of a process for requesting an electronic marker.

FIG. 3 is a flow diagram of one process for verifying an electronic marker request.

FIG. 4 is a flow diagram of a process for purchasing an electronic marker.

FIG. 5 is a schematic illustration of one receipt of the present disclosure.

FIG. 6 is a schematic illustration of an invoice for use with the present disclosure.

FIG. 7 is a schematic illustration of a basic configuration of a system in accordance with an embodiment of the present disclosure.

FIG. 8 is a perspective illustration of an example, rechargeable, hand-held, mobile device adapted to be disposed in a charging and storage base that may be employed in the system shown in FIG. 7.

FIG. 9 is partial rear view illustration of a bar code reader mounted on the mobile device shown in FIG. 8.

FIG. 10 is a perspective illustration of a magnetic strip reader including an electrical wire for connection to the mobile device shown in FIG. 8.

FIG. 11 is a bottom view illustration of the mobile device shown in FIG. 8.

FIG. 12 is a perspective illustration of a charging and storage base in which the mobile device shown in FIG. 8 is adapted to be selectively disposed.

FIG. 13 is a perspective illustration of the mobile device shown in FIG. 8 disposed in the charging and storage device of FIG. 12.

FIG. 14 is a plan view of an image displayed on a touch screen display of the mobile device shown in FIG. 8.

FIGS. 15-47 are plan views of yet other images displayed on the touch screen display of the mobile device shown in FIG. 8.

FIG. 48 schematically depicts the provisioning of multiple extensions of funds to a player over time in accordance with one non-limiting embodiment.

FIG. 49 schematically depicts an issuance of an electronic marker to a player based on the amount of funds extended to the player during gameplay in accordance with one non-limiting embodiment.

FIG. 50 schematically depicts an issuance of an electronic marker to a player based on a partial amount of funds extended to the player during gameplay in accordance with one non-limiting embodiment.

FIG. 51 is a flow chart depicting example processes of an electronic marker management computing system facilitating the issuance of an electronic marker, the redemption of a marker, and extension of funds to a patron, in accordance with one non-limiting embodiment.

FIG. 52 illustrates an example marker issuance and redemption workflow in accordance with one example embodiments.

FIG. 53 illustrates an example extension session workflow in accordance with one example embodiments.

FIGS. 54-57 depict example non-limiting screens provided by an electronic marker management computing system in accordance with various embodiments.

FIGS. 58-72 depict example screens of a mobile device system in accordance with various embodiments.

FIG. 73 schematically illustrates the read-only data retrieval from an electronic marker management computing system in accordance with various embodiments.

### DETAILED DESCRIPTION

Various non-limiting embodiments of the present disclosure will now be described to provide an overall understanding of the principles of the structure, function, and use of the systems and processes as disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in as least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term software is used expansively to include not only executable code, but also data structures, data stores, and computing instructions in any electronic format, firmware, and embedded software. The terms information and data are used expansively and can include a wide variety of electronic information, including but not limited to machine-executable or machine-interpretable instructions; content such as text, video data, and audio data, among others; and various codes or flags. The terms information, data, and content are sometimes used interchangeably when permitted by context.

The examples discussed herein are examples only and are provided to assist in the explanation of the systems and methods described herein. None of the features or components shown in the drawings or discussed below should be taken as mandatory for any specific implementation of any of these systems and methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

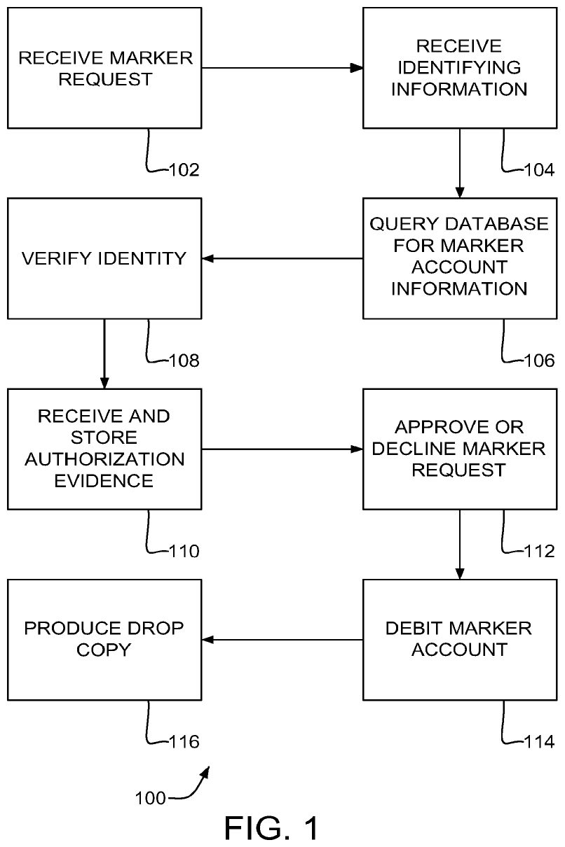

Referring to FIG. 1, the process 100 depicts a flow diagram in accordance with one embodiment of the present disclosure. Process 100 exemplifies one method for electronically handling a marker. It should be noted that the steps described in FIG. 1 are presented in a certain order so as to more clearly describe one example embodiment. However, the order of such steps may be changed and/or selected steps may be omitted when practicing certain embodiments of the present disclosure. As such, the Figures illustrate merely examples and should not be construed as limiting the disclosure in any way.

Process 100 is initiated in step 102, wherein a marker request is received. As known by those skilled in the gambling art, a marker typically is a signed draft against funds or credit maintained at a gaming establishment, such as a casino. In one embodiment, the draft is against a line of credit previously established by the casino for an individual person or entity. In such an embodiment, drafts against the marker account represent use of the credit. To establish such a line of credit, the requester of the marker account applies to the gaming establishment. A credit check is performed against the background of the requester and an appropriate credit limit is established. In another embodiment, the draft is against a debit account which contains a sum of money deposited with the casino by the individual. In such an embodiment, drafts are drawn against such escrowed funds. It is important to note that, in certain aspects of the disclosure, the issuer of the credit is the gaming establishment itself, rather than a third-party credit source, e.g., a bank, financial institution, or credit card company. Third-party credit sources often charge service fees to clients for issuing cash advances. Since, in certain aspects of the disclosure, the establishment is the issuer of the credit, such establishment can control, or preferably eliminate, such service fees. Once such a debit or credit account is established, an authorized individual can request markers against such account. One such request is made in step 102.

In step 102 of process 100, the gaming establishment receives a marker request from the authorized individual. Such a request may come in the form of a verbal request to a table operator, dealer, casino employee, cage operator, or other agent of the gaming establishment. In another embodiment, such a request comes over a network connection, such as the internet, or through another electronic medium, such as a self-serve electronic terminal. Such network requests are particularly well-suited for use with internet-based gaming establishments. Once an establishment is aware of a marker request, the establishment seeks to properly identify if the requester is authorized to use the account. The establishment requests and receives identifying information from the requester.

In step 104 the establishment receives identifying information concerning the requester of the marker. Such identifying information typically comprises data which can be correlated to data already on file with the marker account. Such a correlation step may include referring to a database. When the requester is physically present, the identifying information received may include the requester's physical appearance. In one embodiment, the requester provides a form of electronically readable information, such as a card with a magnetically readable stripe with information stored in a digital format that is optically readable, such as a barcode. In yet another embodiment, such information is transmitted using encrypted electromagnetic waves, such as radio waves. The card may be imbedded with information necessary to identify the account of the requester, such as an account number or a primary key. Alternative forms of identification may include a State issued identification card. In another embodiment, the same form of identification also correlates the instant requester to a history of play for such requester. The history of play may include, for example the amount of time spent at a given game, the amount of cash won or lost, the wager activity, and the like. In such an embodiment, the requester's driver's license number, name, or other such information is correlated to an account number by a relational database. In yet another embodiment, the requester verbally provides identifying information by giving, for example, a name, account number, telephone number, or the like.

In step 106 of process 100, a database can be queried for marker account information based on the information provided by the requester in step 104. Such marker account information can include an identifier such as a digital picture of an individual authorized to use the account and/or a digital picture of such individual's signature. Additionally, such marker account information also includes the credit limit and/or outstanding balance associated with the requester's account. The marker account information so retrieved also can include the bank routing number and account number for at least one cash account that contains sufficient funds to secure the marker. For example, the bank routing number and account number for a checking or money market account may be contained in the marker account information. After such information is retrieved, one or more identifiers may be displayed to allow the opportunity to verify the identity of the requester. In addition to the identifier(s) being displayed, in some embodiments, certain marker account information is displayed.

In step 108, the identity of the requester can be verified by comparing the identifying information provided by the requester to the identifier that resulted from the query of step 106. For example, the picture of the authorized individual retrieved during step 106 may be displayed and compared to the physical appearance of the requester. Alternatively or additionally, the requester may be asked to provide a signature, or digital signature capture, such as on a touch pad, which is then compared to the digital picture of the signature retrieved in step 106. Other suitable identifiers are also contemplated for use with the present disclosure. For example, in one embodiment, the identifier can be a biometric identifier. As is known to those skilled in the art, biometrics is the science of measuring physical properties of living beings. Examples of biometric data include retinal scans, infrared facial readings, feature spacing, fingerprint scans, and the like. Reference may be had to U.S. Pat. No. 6,935,951 to Paulsen et al. (Electronic Signature Capability in a Gaming Machine); U.S. Pat. No. 7,107,245 to Kowalock (Biometric Gaming Access System); U.S. Pat. No. 7,082,213 to Black (Method for Identity Verification); each of which are incorporated herein by reference in their entirety. Other suitable biometric techniques would become apparent to those skilled in the art after benefiting from reading this specification. Such techniques are considered within the scope of the present disclosure.

Once the identity of the requester has been verified in step 108, step 110 can be executed, wherein the requester authorizes the transaction in accordance with certain terms and the evidence of such authorization is digitally stored by the gaming establishment. In one example embodiment, the terms so authorized state that the marker is secured by a certain cash account (specified in the marker account information retrieved in step 106, for example) such that, if the marker is not redeemed within a predetermined period of time, the gaming establishment is authorized to deduct the marker value from the cash account by electronic fund transfer (EFT) in redemption of such marker. In such an embodiment, the marker functions as a secured loan. Methods for performing such EFT are well known in the art. In one embodiment, Automated Clearing House (ACH) software is used. Evidence of the acceptance of such terms by the requester can be stored for later retrieval. Such evidence may be in the form of a signature that is provided on a touch-sensitive screen. In another embodiment, such evidence is in the form of a digitally recorded fingerprint or other digitally recorded biometric data. Such evidence can be digitally stored, for example, on the gaming establishment's internal computer network, or associated service model as software as a service active server pages (ASP), and associated with the instant marker request. In one embodiment, the software system of the gaming establishment automatically redeems markers by electronic transfer of funds when a marker reaches the predetermined age. In this manner, little or no personal intervention by a human being is necessary to handle the electronic marker.

In some embodiments, the gaming establishment is provided with an opportunity to approval or decline a marker request. Such an opportunity can be provided in step 112. The establishment may choose to decline the marker request for a variety of reasons. In one embodiment, the status is found to be unsatisfactory (the account has a low balance, is closed, etc.), the request may be declined. Alternatively or additionally, the request may be declined because the marker account itself has an insufficient limit left to cover the requested marker. Other reasons for declining the request include the identity of the requester not being verifiable, a note or flag being entered into the marker account information which may indicate a history of problems, or for any other suitable reason. In one embodiment, the requester may prearrange with the gaming establishment a set of prescribed limits or criteria that may, for example, put restraints on the requester's gambling impulses such as by limiting the amount the marker account may be depleted in any given time interval or such as by prohibiting any request made from a certain table pit area or other location in the casino. If any marker request would exceed such limits or criteria, then the gaming establishment may deny the marker request. In another embodiment, the gaming establishment may refuse a marker request if consecutive requests occur at times and places in the casino where it would be humanly impossible or unfeasible to be made by the authorized requester. In some embodiments, the execution of step 112 is logged to a database. This log may include, for example, the date stamp and timestamp of the request as well as other information pertaining to the request itself. In the embodiment depicted in FIG. 1, such an opportunity to decline follows authorization by the requester (step 110). In another embodiment, not shown, such an opportunity to decline occurs prior to step 110. In yet another embodiment the data is retrieved (step 106), the identity of the requester is verified (step 108), and the approval decision (step 112) occur at substantially the same time. Should the establishment decide to approve the marker request, then step 114 is executed.

In step 114 of process 100, the desired marker value is deducted from the available limit (e.g. deducted from the credit limit or debited from the escrow funds). The updated limit is then associated with the marker account. In one embodiment, the marker account information, which includes evidence of authorization, current balance, and an itemized history of marker requests, is kept at the gaming establishment solely in electronic form. This account information may also include a time and date stamp that corresponds to the time and date each request was approved and may include the location where the request was approved. Advantageously, this reduces the dependency upon a paper filing system, printer, and associated labor costs, thereby decreases the operating expenses of the establishment. As a further advantage, a single invoice can contain an itemized history of multiple marker requests. This is a significant advantage over the prior art. Due to the paper-based nature of prior art marker systems, a carbon copy receipt was generated for each request. A given requester is likely to make dozens of marker requests during a single visit to the establishment. The volume of paperwork generated in such prior art systems is cumbersome to manage. In addition, the elimination of voids, or transactions which were incomplete, are eliminated using this system. By providing a single invoice with an itemized history of multiple marker requests, such paperwork and labor costs are substantially reduced.

In one embodiment, step 116, which is optional, is executed. In step 116, a drop copy is produced for use by the gaming establishment. The drop copy is used by the establishment to help balance the actual currency in a table dealer's rack with the expected currency in the rack. In one embodiment, when the drop copy is produced, one or more other departments in the establishment are notified electronically in real time. For example, one or more of the following departments may be notified: the accountant, the cashier, the main cage, and the bank cage. In one embodiment, multiple departments are simultaneously notified. Casino currency may be provided to the requester before or after step 116.

Once the marker account has been updated, the requester is provided casino currency whose value is commensurate with the approved marker value. In one embodiment, the items so provided are casino chips, and their value is equal to the approved marker value. In another embodiment, the casino chips are provided, and a bonus or gift amount is also included as an incentive to induce customers to use the electronic marker system. In one embodiment, such a bonus amount is in the form of additional casino chips. In another embodiment, such a bonus amount is in the form of a gift certificate or other casino credit.

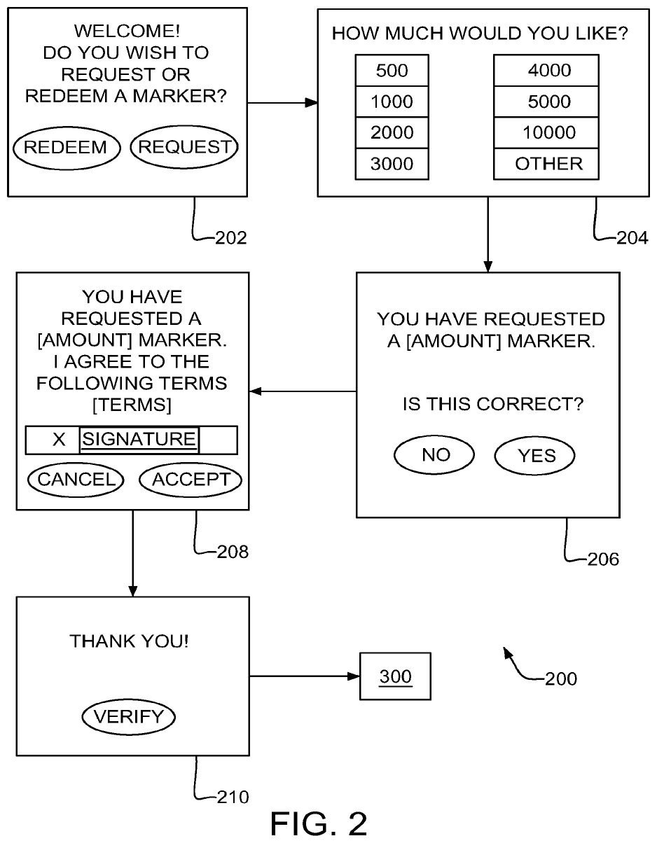

Referring now to FIG. 2, and the process 200 depicted therein, process 200 is a more detailed accounting of certain aspects of process 100 of FIG. 1. It should be recognized that the embodiment depicted in FIG. 2 is only one particular embodiment of one process of the present disclosure, and there is no intent to limit the disclosure to such a specific embodiment. Throughout the following example, the requester is assumed to be the individual performing many of the steps indicated. However, other individuals, such as agents of the establishment, may also perform such steps.

Process 200 is initiated when a gaming establishment receives a request to provide a marker. After making such a request, the requester provides identifying information to the gaming establishment. In the example embodiment depicted in FIG. 2, the requester provides a magnetic stripe card which is passed through the magnetic stripe reader of an electronic device. Such an electronic device contains software necessary to execute the methods described in this specification. The device is comprised of a digital display and can be a hand-held device. Examples of suitable hand-held devices include personal digital assistants (PDA's), tablet computers, and especially tablet computers with touch sensitive screens. In one embodiment, the device is self-contained such that all necessary software, services, and databases are housed within the device. In another embodiment, the device is connected to a server through a network or the Internet, wherein such software, services, and databases are stored, at least in part, on the server. For example, a single server may host a database which relates a unique identifier to account numbers and thus to account information. Several user computers, which are connected to the server through a network or the Internet, can obtain a unique identifier using data such as a name, account number, telephone number, etc.) from a requester, submit such identifier to the server, and thus query the database directly or through a service to retrieve the marker account information. In one such embodiment, the connection to the server is a wireless connection. In another embodiment, certain data is stored on the user machines (such as the unique identifier and data associated with the unique identifier) and certain other data is stored on the server (such as the unique identifier and the other marker account information). Such an embodiment advantageously permits the user machines to verify the identity of a requester without utilizing the network, Internet, or server resources, while securely maintaining the marker account's financial information (such as the account numbers for the cash account) on a secure server. Such a secure server is kept in a location that is difficult for the general public to reach and requires adherence to specific and strict authentication protocols for electronic access. Further, it is to be appreciated that instead of a magnetic stripe card being passed through the magnetic stripe reader of an electronic device, a variety of other information transfer techniques can be used, including both contacting and non-contacting techniques.

Referring again to process 200, in the embodiment depicted in FIG. 2, the identifying information is read by the card reader, and screen 202 is displayed. In some embodiments, that screen 202 be a touch-sensitive screen. The screen 202 may be located on a device disposed at a point-of-sale (such as a gaming table) or at a traditional point of transaction (such as the cage of a casino).

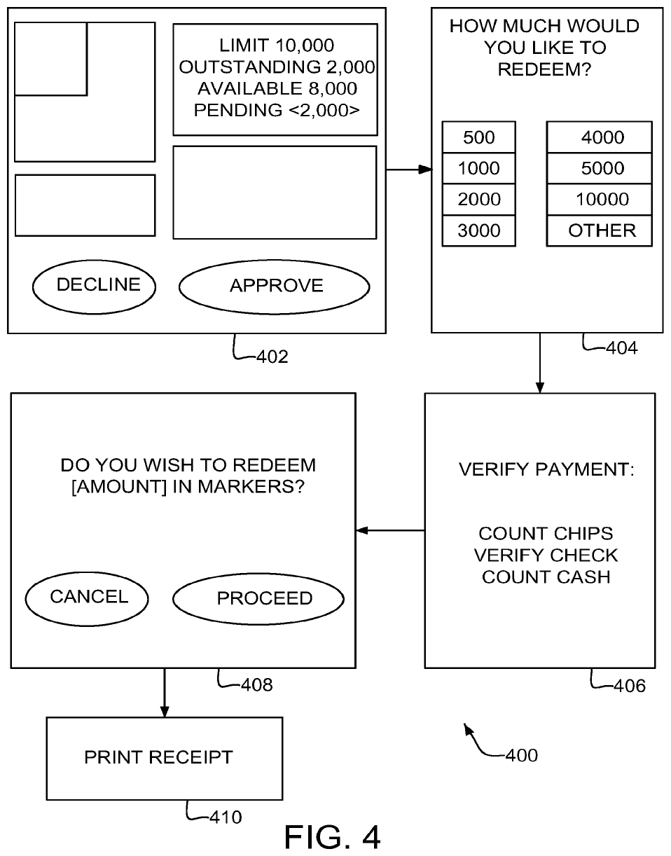

Referring again to screen 202, the requester of the marker can be provided with a welcome screen which asks the requester if he or she would like to request or redeem a marker. If the requester selects “Redeem”, then process 400 of FIG. 4 is executed which permits the requester to buy a marker back. If the requester selects “Request”, then screen 204 is displayed which permits the requester to obtain a marker.

Screen 204 prompts the requester to indicate a desired marker value. In the embodiment depicted in screen 204, several predetermined values are presented, such as $500, $1000, $2000, etc. One value, “Other”, which has not been predetermined is also presented. The requester may select one of the predetermined values by pressing the touch-sensitive screen at the appropriate location. In another embodiment, where the screen is not touch-sensitive, the requester selects the desired value using an input device (not shown) such as a keyboard, keypad, mouse, or similar input device. Should the “Other” value be selected, an additional screen is presented (not shown) wherein the requester can input the desired amount. Once the desired marker value has been selected, the requester confirms the transaction.

In screen 206, which is optional, the device indicates what amount has been requested, thus confirming the selected amount is the desired marker value. The requester is asked to confirm the value (by pressing yes) or declining to proceed (by pressing no). If the requester declines, then screen 202, screen 204, or another suitable screen may be displayed. If the requester confirms the amount is correct, then authorization screen 208 is displayed.

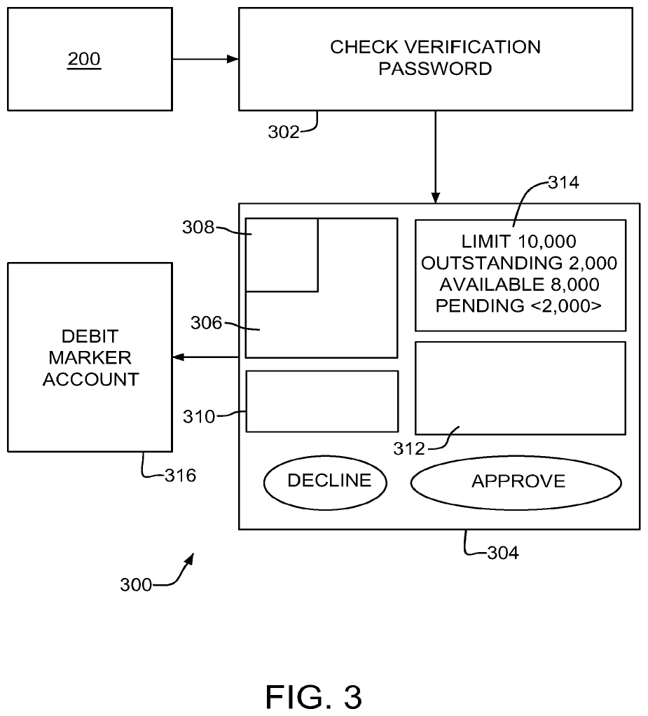

Authorization screen 208 displays the terms of the marker agreement. If the requester declines such terms, then an earlier screen, such as screen 202 or 204, may be displayed and no marker is issued. In the embodiment depicted, the requester accepts such agreement by signing within the signature box on the touch-sensitive screen and thereafter pressing “accept”. This signature is one means for providing evidence of acceptance of the terms of the marker agreement. Such evidence of acceptance is then stored in a digital storage location, such as a network server, or a data storage unit disposed within the device itself. Other methods for providing evidence of acceptance include, but are not limited to, providing a personal identification number (PIN) or other password, or by providing a fingerprint or other biometric data. Such evidence be stored digitally. In one embodiment, the signature is digitally stored until the marker is paid. In certain embodiments, the marker is printed with the digital signature displayed thereon. The printing may occur at a secure location, such as the casino cage, a casino accounting facility, or another secure location. Once the terms have been authorized, closing screen 210 is shown to the requester. The verification button on screen 210 initiates verification process 300 (see FIG. 3) that can be executed by an agent of the gaming establishment.

Referring now to FIG. 3 and verification process 300 depicted therein, process 300 can be initiated subsequent to process 200 and begins with the execution of security step 302, wherein a verification password is checked. Certain agents of the gaming establishment know this password. Such a security step, which is optional, helps strengthen the security associated with the verification process by ensuring that only authorized personnel can access the marker account information. In one embodiment, such a security step includes receiving both a user name and a password. In such embodiments, the verification system can track which agent of the gaming establishment verified the marker. If the correct password is entered, the device uses the identifying information provided to query a database for the marker account information which is associated with the identifying information. The marker account information is then displayed on screen 304.

Screen 304 of FIG. 3 includes marker account information such as picture 308 which is a digital photograph of an individual authorized to use the associated marker account. Box 306 contains other identifiers such as a name, address, telephone number, account number, and the like. Box 310 contains a digital photograph of a sample of the signature of the individual authorized to use the marker account. Box 312, which is optional, provides additional information such as, for example, the play history of the authorized individual or other notes associated with the account. For example, any security problems the establishment has had with the authorized individual may be listed here. Box 314 contains marker account information such as, for example, account limits (either a credit limit or the debit limit), outstanding balance, available balance, and the current (pending) transaction. Other marker account information may include the routing number and account number of the cash account which secures the marker account. In the embodiment depicted, the gaming establishment can see that the marker account is a line of credit that has $8,000 available credit and a $2,000 marker has been requested. The agent of the gaming establishment can decide to decline the request by pressing “Decline” or proceed with the verification and press “Approved.” If the verification is approved, step 316 is executed wherein the line of credit is debited (the outstanding balance becomes $4,000, the available balance becomes $6,000, and the pending balance becomes $0) and the marker is issued to the requester. The current $2,000 marker is recorded and entered into a transaction history file that is associated with the marker account. Other identifiers that may be displayed in screen 304 include, but are not limited to, biometric data such as fingerprint data. In one such embodiment, a software program compares the digital image of the biometric data to that obtained from the requester. Such a software program determines if the biometric data so provided matches the biometric data of record in the marker account. Other biometric data which may be stored in the marker account information and used as an identifier, but which need not be displayed, include voice recognition patterns, retinal scans, and similar data wherein a software program performs the comparison, rather than a human being.

FIG. 4 is a depiction of one method 400 for redeeming a marker. Screen 402 is presented when “Redeem” is selected from screen 202 of FIG. 2 after providing identifying information. In one embodiment, not shown, a security step precedes the display of screen 402 to ensure that only an agent of the gaming establishment can access the marker account information shown on screen 402. In yet another embodiment, such a security step ensures that only the authorized individual associated with the account can access the marker account information. For example, the authorized individual may access a marker account over a network, such as the internet. Such individual may choose to redeem the electronic markers through digital means—for example by electronic funds transfer or by credit card payment. In another embodiment, the display of screen 402 is optional. Screen 402 is similar in many respects to screen 304 of FIG. 3, but differs in that the options presented to the user are “History” and “Redeem” rather than “Decline” and “Approve”. If “History” is selected, then an itemized accounting (not shown) of certain past markers associated with the instant account is displayed along with their respective status (e.g. outstanding or redeemed) of each such marker. If “Redeem” is selected, then screen 404 is presented.

Screen 404 of FIG. 4 provides a method to indicate how much should be credited against the outstanding balance of the marker account. In the embodiment depicted in screen 404, several predetermined options are presented, such as $500, $1000, $2000, etc. One option, “Other,” which has not been predetermined, is also presented. The user may select one of the predetermined options by pressing the touch-sensitive screen at the appropriate location. In another embodiment, where the screen is not touch-sensitive, the user selects the desired denomination using an input device (not shown) such as an alphanumeric keyboard, a numeric keypad, a mouse, or similar input device. Should the “Other” option be selected, an additional screen is presented (not shown) wherein the requester can input the desired amount.

In another embodiment of screen 404, not shown, an itemized list of outstanding markers is presented and the user selects which marker is to be redeemed. In one such embodiment, the user is required to redeem the oldest marker first. In another embodiment, the user can select any outstanding marker to redeem. Once the user has selected the amount that is to be redeemed to the account, such an amount is verified in step 406.

In step 406 of method 400, the amount to be redeemed is verified. In one embodiment, an agent of the gaming establishment verifies the amount to be redeemed by, for example, counting the chips or cash provided by the requester, inspecting a check, approving the user of a credit card, or performing an electronic fund transaction using a debit card or similar transaction. In another embodiment, an electronic machine performs verification step 406 by counting tokens using a token counting machine, by reading a card or payment vehicle with a magnetic stripe or other identifier and performing the associated credit, debit, or transfer transaction, or by similar means. Once the redemption has been verified the device presents screen 408, which is optional, to confirm the redemption. The amount to be credited is displayed in confirmation screen 408. In some embodiments, not shown, the payor must provide evidence of authorizing such redemption. For example, when a credit or debit card is used, the user may be required to provide a digital signature on a touch-sensitive pad or PIN before the transaction can be verified and confirmed. Once the transaction is confirmed, the user presses “Proceed” and a receipt of such redemption is generated in step 410, which is optional.

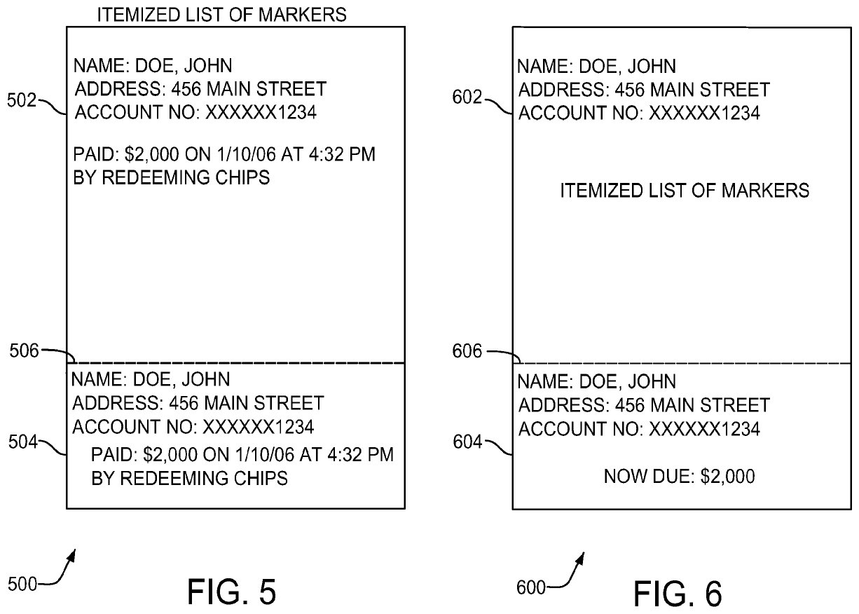

In step 410 a receipt is generated for the payor. One such receipt is illustrated in FIG. 5. Receipt 500 is comprised of a payor record 504 and a payee record 502, separated by tearing the receipt at perforation 506 and providing payor record 504 to the payor. The payee may retain payee record 502. Receipt 500 contains certain information such as the payor's name, address, the redemption value, the redemption date, and the redemption method. In the embodiment depicted, the redemption is made by providing $2,000 in casino chips. In the embodiment depicted, only a partial account number may be the account number of the marker account and/or the account number of the account used to redeem the marker (such as a credit card or cash account). In another embodiment, an invoice, rather than a receipt is generated at certain intervals. Such an invoice is depicted in FIG. 6.

In FIG. 6, invoice 600 is shown. Invoice 600 is similar to receipt 500 of FIG. 5, but differs in that an amount due is listed, rather than an amount redeemed. In some embodiments, the gaming establishment will, at certain intervals, generate invoice 600 for certain marker accounts which have non-zero balances. Such invoices can be mailed to the address of record which is associated with the marker account and can contain an itemized list of outstanding markers, sorted by the date and time they were verified or requested. In one embodiment, the gaming establishment has been previously authorized to charge outstanding markers to an existing cash account, such as a banking account. In one such embodiment, invoice 600 reflects such redemption having been made. If such redemption was made by electronic funds transfer, the invoice may show a tracking number that is associated with such transfer.

In another embodiment the time interval between invoice cycles and the predetermined time period the establishment will wait before debiting the cash account by electronic transfer are staggered such that the cash account is only debited if the invoice goes unpaid for more than an acceptable period of time.

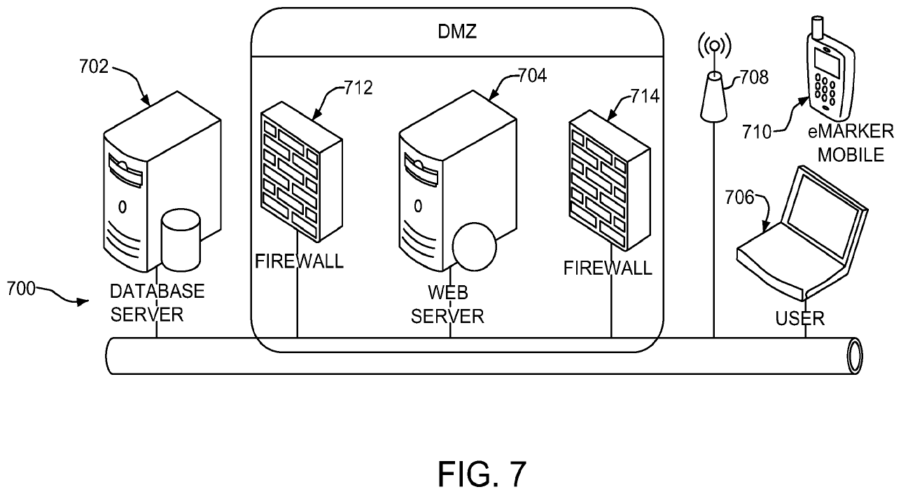

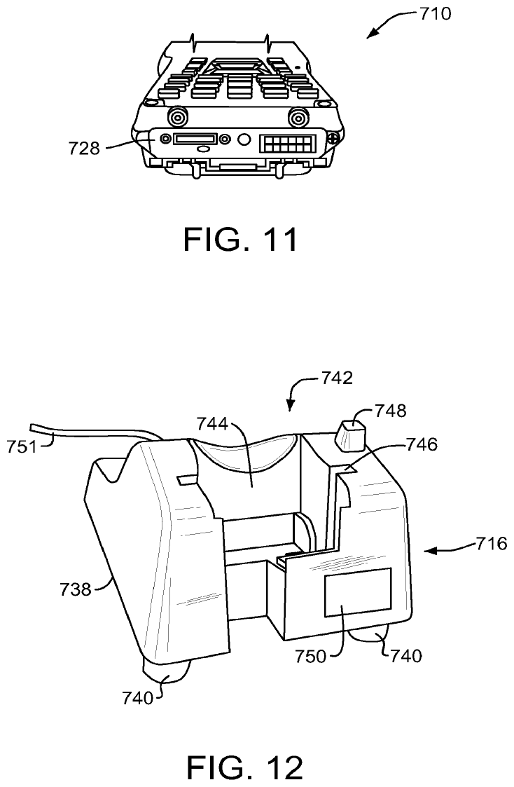

The operation of an example embodiment of the system and method of the present disclosure employing a rechargeable, wireless, hand-held, mobile device will now be described with reference to FIGS. 7-47.

There is shown in FIG. 7 a schematic illustration of a basic configuration for a system 700 in accordance with an example embodiment. The basic configuration includes a database server 702, a web server 704, a user computer processor in the form of a laptop computer 706 or other suitable computer (such as a tablet computer, for example), a wireless transmitter/receiver 708, and a mobile device 710. The web server 704 can be isolated by firewalls 712, 714. The various components of the system 700 are electronically interconnected whereby the database server 702 may be accessed via either the user laptop computer 706 or the mobile device 710. Additional web servers may be clustered or load balanced to prevent system failure in the event one web server goes offline or experiences a failure. Similarly, additional database servers may be clustered or replicated to provide redundancy and additional capacity.

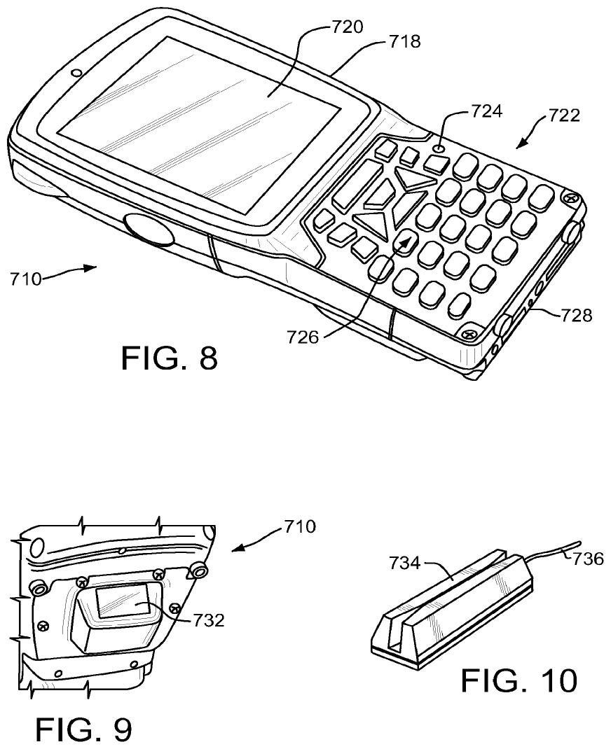

FIGS. 8-13 depict perspective illustrations of an example, rechargeable, hand-held, mobile device 710 and a charging and storage base 716 in accordance with one non-limiting embodiment. The mobile device 710 generally includes an exterior housing 718 that contains an upper touch screen display 720 and a lower array 722 of depressible, manually activated buttons including a power on/off button 724 and a key pad 726. While manually activated buttons are schematically illustrated, it is to be appreciated that other embodiments of the mobile device 710 may provide similar functionality using a touch-screen interface. The housing 718 contains a rechargeable battery (not shown) and electrical docking ports 728 that are in electrical communication with the battery and are adapted to mate with corresponding electrical prongs protruding up from the cradle portion of the charging and storage base 716. As shown in FIGS. 9 and 10, the housing 718 may also contain a bar code scanner 732 and a magnetic swipe reader 734, although the bar code scanner 732 and the magnetic swipe reader 734 may be remote from the housing 718 and electrically connected thereto by wiring 736.

As shown in FIG. 12, in accordance with one embodiment, the charging and storage base 716 generally includes a block-like stand 738 mounted on and above a plurality of pads or feet 740. The stand 738 can includes a centrally disposed cavity or cradle 742, the bottom of which possesses a pair of protruding electrical docking prongs 744 adapted to mate with the corresponding electrical docking ports 728 of the mobile device 710 and includes a latch mechanism 746 for selectively retaining or locking the mobile device 710 within the cradle 742. The charging and storage base 716 further includes a manually depressible release button 748 for selectively releasing the latch mechanism 746 whereby the mobile device 710 may be disengaged and removed from the stand 738. The charging and storage base 716 further includes a charge status indicator 750 that possesses LEDs for indicating the level of charge of the battery in the mobile device 710 and an electrical wire 751 and plug (not shown) for connecting the charging and storage base 716 to an electrical outlet or other power source.

The charging and storage base 716 provides a place to store the mobile device 710 when the mobile device 710 is not in use and also to recharge the battery of the mobile device 710. The mobile device 710 is automatically recharged when seated within the cradle 742 of the charging and storage base 716. For this purpose, the charging and storage base 716 can be constantly connected to an electrical outlet or other power source to facilitate such recharging of the battery.

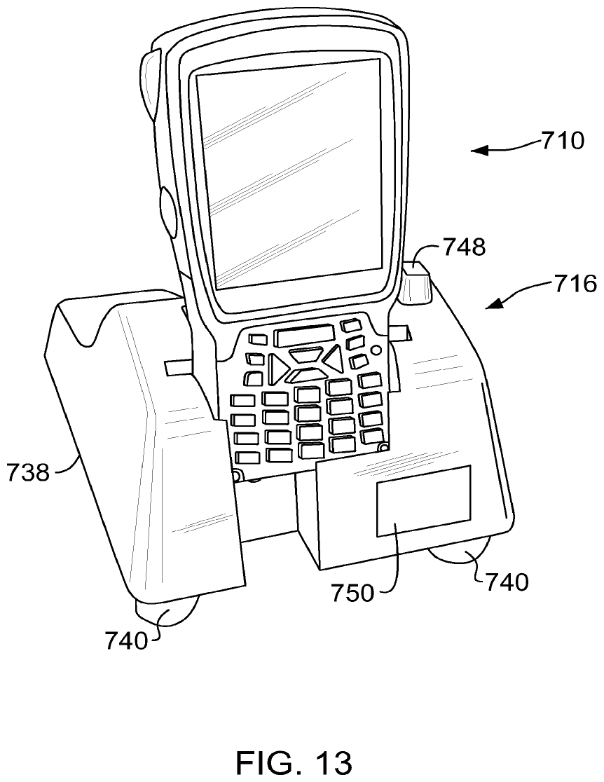

To seat the mobile device 710 within the cradle 742, the bottom end of the mobile device 710 is dropped into the cradle as such that the electrical docking ports 728 align with and extend snugly about the electrical docking prongs 744 in a mating disposition. When the mobile device 710 is so disposed within the cradle, the latch mechanism 746 will create a “click” sound that helps indicate to the user that the mobile device 710 is properly disposed within the cradle 742 for storage and recharging of the battery within the mobile device 710. In order to remove the mobile device 710 from the cradle 742, the user presses the latch release button 748 on the charging and storage base 716, which in turn will actuate the latch mechanism 746 so as to release the mobile device 710 from its disposition within the cradle 742. FIG. 13 shows the mobile device 710 disposed within the cradle 742 of the charging and storage base 716 such that the battery of the mobile device 710 may be recharged.

The charge status indicator 750 on the charging and storage base 716 can be configured to provide no illumination if the charging and storage base 716 is not plugged into an electrical outlet or otherwise is not connected to a source of power. The charge status indicator 750 can be configured to illuminate with a red LED light if the charging and storage base 716 is connected to an electrical outlet or other power source, but the mobile device 710 is not docked within the cradle 742 in a position for recharging. The charge status indicator 750 can be configured to illuminate with a blinking green LED light when the mobile device 710 is being charged within the charging and storage base 716, and illuminates with a continuous green LED light when the mobile device 710 is fully charged.

The power on/off button 724 of the mobile device 710, when depressed, can illuminate an associated green LED light when power is actuated, and re-depression of the power on/off button 724 can de-activate the associated green LED light. The mobile device 710 may be provided with alternate power activation features, such as pressing various function keys of the keypad 726 if the power on/off button 724 becomes inoperable.

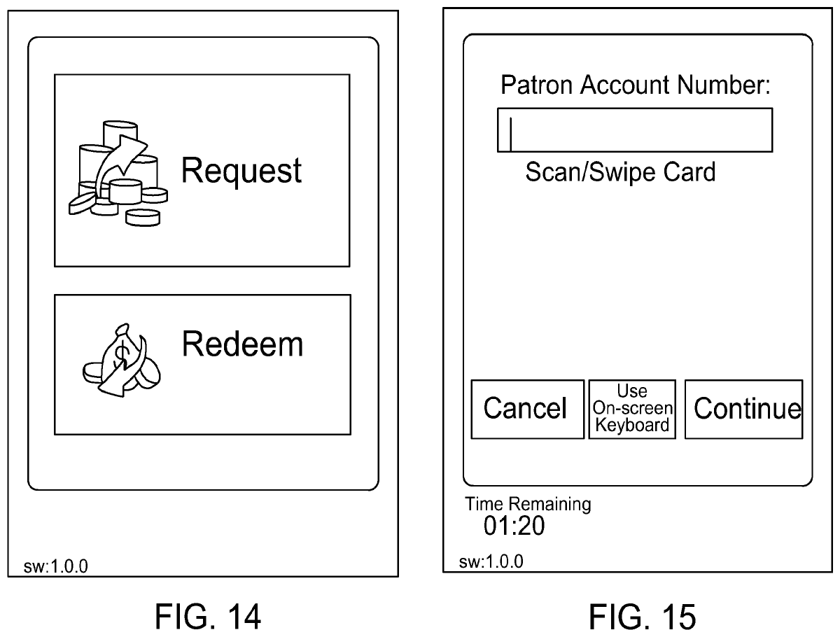

FIG. 14 shows an example “home screen” image displayed on the touch screen display 720 of the mobile device 710. The home screen offers the user of the mobile device 710 with a choice between making a marker request and redeeming a marker. The user touches the screen above the appropriate, selected choice. When used herein, unless otherwise indicated, the term “touch” means either to physically contact or to place a finger or other object sufficiently close to the touch screen to be detected as selecting a feature associated with an area of the screen, in accordance with well-known touch screen technology.

The following description of an example operation of the mobile device 710 and system 700 will explain how to request and obtain a marker in accordance with various embodiments. Later, the process of redeeming a marker using the mobile device 710 will be described. It will be appreciated that microprocessors within either the mobile device 710 or the user server computer 706 execute and regulate the screen features and the responsive instructions, and that either or both the mobile device 710 or the laptop computer 706 (such as with its own screen and touch screen technology) may be utilized in connection with the following operation. The following descriptions of operation will reference only the mobile device 710 for convenience and simplicity.

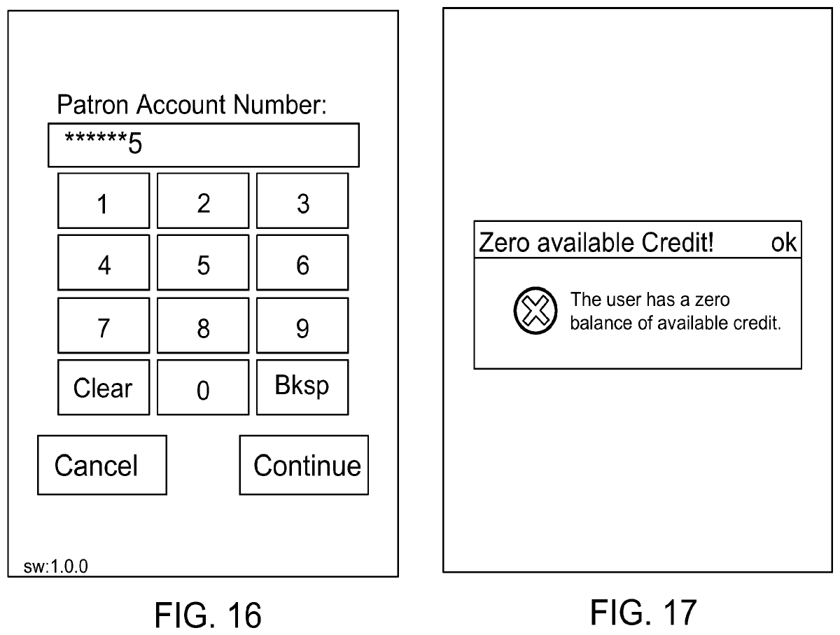

If the user chooses to request a marker, the mobile device 710 can display a page screen such as that shown in FIG. 15. The patron account number associated with the patron making the marker request can then be entered using the keypad image displayed on the touch screen display 720 of the mobile device 710 as shown in FIG. 16. In order to use the keypad, the user touches the screen above the field “use on-screen keypad” as shown in FIG. 15. Upon touching the “use on-screen keypad” field, the screen 720 will display a keypad, which is also operable via touching the screen, as shown in FIG. 16. When the keypad has been used to enter the desired patron account number, the screen is touched over the field “continue” as shown in FIG. 16, and the system 700 processes the patron account number to determine if the number matches a patron account number maintained in the casino's database operated by the database server 702. The system 700 verifies that the patron account number entered on the page screen shown in FIG. 15 corresponds with a patron account number maintained in the database. Presuming that the patron has entered a valid patron account number and wishes to proceed with the marker request, the screen is touched over the “continue” field as shown in FIG. 15. If the patron does not wish to proceed with the transaction, then the screen is touched above the “cancel” field shown in FIG. 15 or 16. If the patron account number is invalid, then the display in FIG. 15 will display an appropriate message.

As is to be readily appreciated, FIGS. 15-16 are merely example techniques for receiving a patron account number, as any suitable technique can be utilized to receive such account number (such as an optical scanner, near field communications, and the like). For example, the patron account number may be entered into the mobile device 710 by scanning a barcode located on the patron's player card, which contains a coded version of the patron account number. The barcode reader 732 associated with the mobile device 710 can scan the barcode and translate the barcode into an associated patron account number, and then display that scanned patron account number on the screen shown in FIG. 15.

In yet another alternative embodiment, if the mobile device 710 possesses an attached magnetic strip reader 732, then a magnetic strip encoded with the patron account number on the player's card may be passed through the magnetic strip reader 734, which coordinates with a microprocessor in the mobile device 710 to decode a patron account number encoded in the magnetic strip on the player's card, and that causes such patron account number to appear on the screen 720 shown in FIG. 15.

The screen shown in FIG. 15 can also include a timer display that counts down a predetermined amount of time remaining to enter a patron account number and to select either the continue field or cancel field. If such activities have not occurred within the predetermined amount of time for performing such transactions, then the workflow will be terminated, and mobile device 710 will automatically display the screen shown in FIG. 14.

For security purposes, the screen shown in FIGS. 15 and 16 may display asterisks for each alphanumeric or other indicia of the patron account number, or may display a combination of asterisks and indicia of the player account number, such as displaying asterisks except for the last four indicia of the patron account number. Also, the “continue” field will not be displayed in the screen shown in FIGS. 15 and 16 until and unless the patron account number has been entered either by scanning the barcode associated with the player's card, by swiping a magnetic strip on the player's card, or by entering the patron account number via the keypad.

If, after entering the patron account number and touching the screen of the “continue” field, the system 700 determines that there is no credit available or no remaining funds on deposit, the screen can display the message shown in FIG. 17. If the user touches the screen above the “ok” field as shown in FIG. 17, then the mobile device 710 will display the home screen shown in FIG. 14.

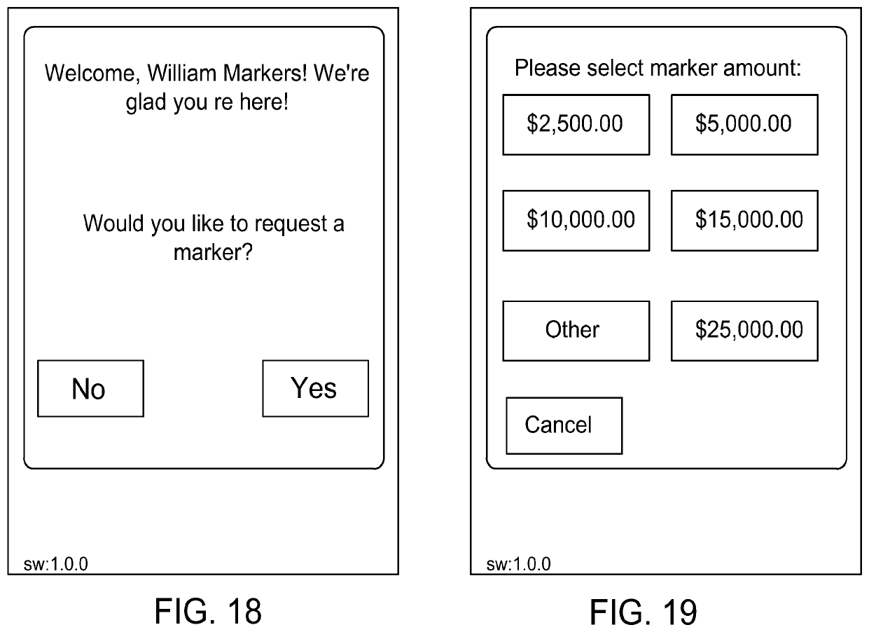

Presuming that the patron account number has available credit or funds on the deposit, then the mobile device 710 can display a screen such as shown in FIG. 18, which includes the patron's name associated with the patron account number. If the patron's name is incorrect, and the patron decides not to continue with requesting a marker, then the user may touch the screen above the “no” field as shown in FIG. 18, which will return the screen to the home page shown in FIG. 14. If the patron's name is correct, and the patron wishes to continue with the marker, request, then the user continues by touching the screen above the “yes” field as shown in FIG. 18, which can display the screen shown in FIG. 19. The user then selects one of the fixed, predetermined values of the marker to be requested, which are displayed in FIG. 19 as, for example, $2,500.00, $5,000.00, $10,000.00, $15,000.00, and $25,000.00. Alternatively, the patron may select some other amount by touching the screen above the “other” field as shown in FIG. 19. By touching the field above one of the fixed, predetermined amounts, the patron is selecting that amount as a marker request. The number of fixed, predetermined amounts appearing on the screen shown in FIG. 19 may be selectively varied, and the fixed, predetermined amounts displayed may vary. For example, if the patron has between $5,000.00 and $10,000.00 of credit available or funds remaining, then the fixed predetermined amounts as shown on the screen may be $250.00, $500.00, $1,000.00, and $5,000.00, and if the patron has between $50,000.00 and $100,000.00 of credit available or funds remaining, then the amounts as shown on the screen may be $2500.00, $10,000.00, $50,000.00, and $100,000.00.

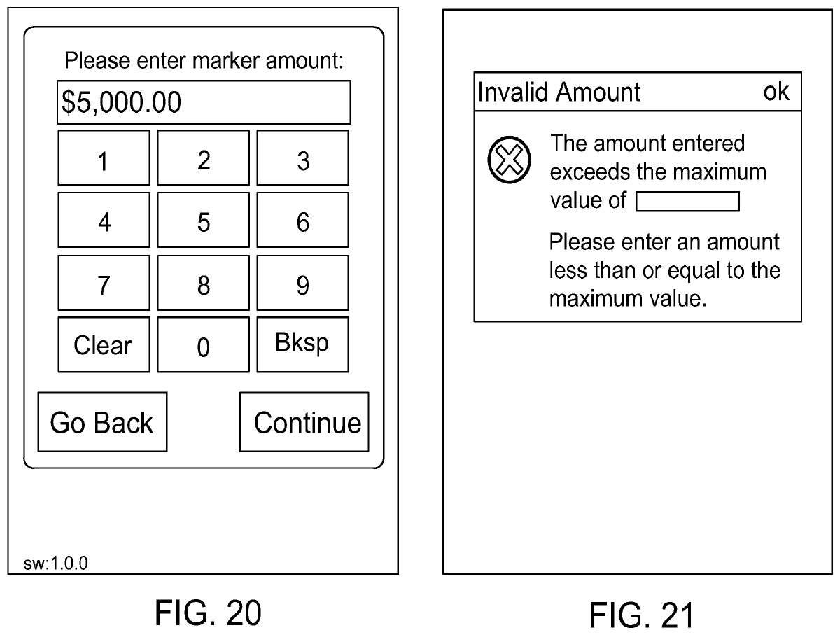

If the user wishes to select an amount other than the displayed, fixed, predetermined amounts, the user touches the screen above the “other” field, which will generate the screen shown in FIG. 20, which includes a keypad display very similar to the display shown in FIG. 16. The keypad may be used to select a dollar amount, which will appear in the field under the wording “please enter marker amount:”. If the user makes a mistake in entering the dollar amount, the user may touch the screen above the “clear” field or touch screen above the “bksp” (i.e. backspace) field to erase all or the last digit, respectively, of the amount entered. If the patron changes his mind about selecting an amount other than a fixed, predetermined amount, the user may touch the screen above the “go back” field, which will cause the screen shown in FIG. 19 to reappear.

If the patron does not want to continue with the marker request, then the user may touch the screen above the “cancel” field as shown in FIG. 19, which will discontinue the transaction and return the mobile device 710 to the home screen shown in FIG. 14.

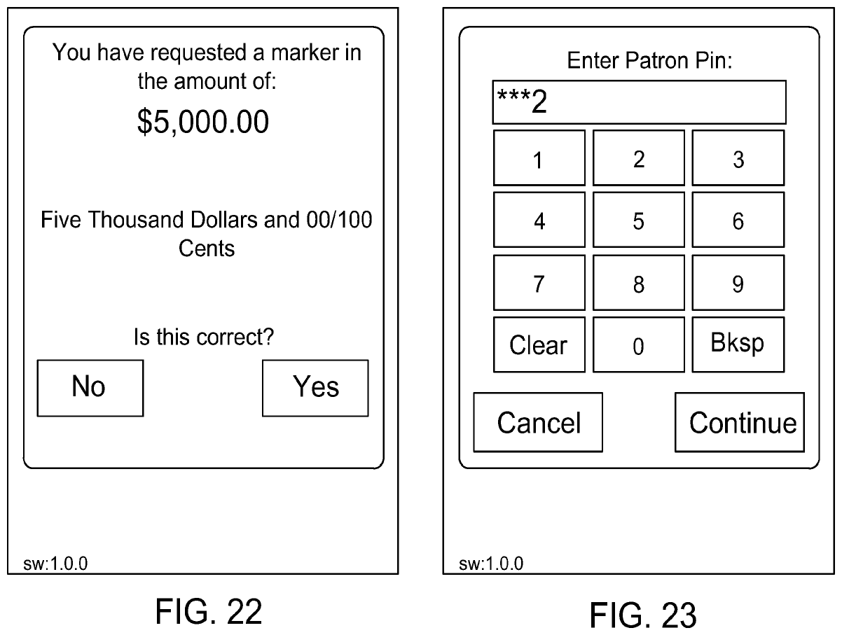

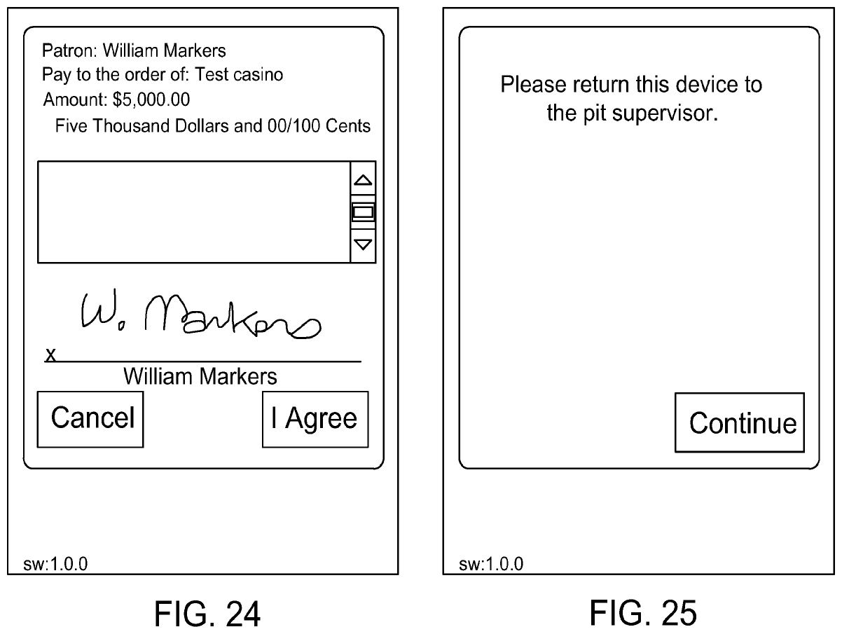

If the patron decides that the selected marker amount is desired, then the user may touch the screen above the “continue” field. The system 700 will then compare the marker amount selectively requested to the patron's available credit or remaining funds associated with the patron account number and the patron name. If the request exceeds the amount available, then the mobile device 710 will display the screen shown in FIG. 21, which will display the maximum value of the credit available or funds remaining on deposit. By touching the screen above the “ok” field shown in FIG. 21, the screen shown in FIG. 19 will reappear. If the requested amount is less than the available credit or funds remaining on deposit, then the mobile device 710 will display the screen shown in FIG. 22, which displays the amount of the requested marker. If the patron changes his mind about the requested marker, then the user may touch the screen above the “no” field, which returns the screen to that shown in FIG. 19. If the patron wishes to proceed with the marker request, then the user touches the screen above the “yes” field, which will cause the screen shown in FIG. 23 to appear, which includes features very similar to those associated with the screen shown in FIG. 16. The patron then enters by touching the screen above the appropriate number fields the patron's PIN number provided by the casino to the patron in connection with the patron's account. By touching the screen above the “clear” field or the “bksp” field, the entire PIN number or the last indicia of the PIN number, respectively, may be erased. For security purposes, the display screen shown in FIG. 23 may show an asterisk for each indicia of the PIN number entered, or may display a combination of asterisks and indicia for the PIN number, such as by displaying asterisks except for the last four indicia of the PIN. If the PIN number entered is invalid or does not correspond with the patron account number, then an appropriate message will be displayed. If the patron decides not to proceed with the marker request, then the user may touch the screen above the “cancel” field, which will cause the home screen shown in FIG. 14 to reappear. Alternatively, if the patron wishes to continue with the marker request, then the user touches the screen above the “continue” field, which will cause the screen shown in FIG. 24 to appear. In accordance with various embodiments, the “continue” field does not appear until after a sufficient number of indicia has been entered for the PIN, so that the user is required to enter an appropriate number of PIN indicia before the patron is allowed to continue with the marker request.

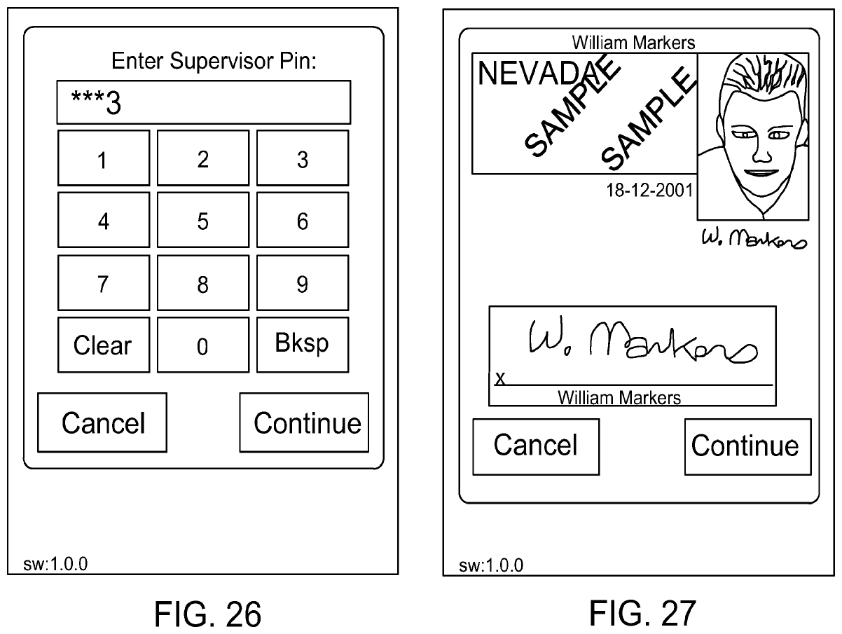

When the mobile device 710 displays the screen shown in FIG. 24, the mobile device 710 can behanded to the casino patron. Prior to that time, a mobile device 710 can be handled only by casino personnel, such as the pit boss, for example. The screen as shown in FIG. 24 includes the patron name, the name of the casino, and the amount of the marker request, as well as a concise authorization statement containing contractual language. The patron then uses a plastic pen or similar implement and places the tip of the plastic pen, other implement, or their finger on the screen above a region for the patron's signature, and then can inscribe the signature. If the patron wishes to discontinue the marker request then the user may touch the screen above the “cancel” field, and the home screen shown in FIG. 14 will reappear. Alternatively, if the patron wishes to continue with the marker request, then the patron will touch the screen above the “I agree” field. In accordance with various embodiments, the “I agree” field will not appear until the system 700 detects a sufficient, predetermined amount of inscription in the field for the signature so that the signature must be completed before the patron agrees to the contractual arrangement. When the screen is touched above the “I agree” field after the signature has been inscribed in the field for the signature, the screen shown in FIG. 25 will appear. The user will then touch the screen above the “continue” field, and the screen shown in FIG. 26 will appear. The casino personnel then enters his casino identification number either using the on screen keypad, or by scanning the barcode on the personnel's employee card, or by swiping a magnetic strip on the personnel's employee card through the reader. The keypad may be used in a manner similar to that previously described reference to FIGS. 16 and 23.

When the screen is touched above the “continue” field shown in FIG. 26, the screen display shown in FIG. 27 will appear. That screen display can show, for example, the patron's photo identification on file with the casino, which may be, for example, a replication of the patron's driver's license, passport, or casino membership card and which will display the patron's signature on file with the casino. The display screen shown in FIG. 27 can also display the signature of patron inscribed on the screen shown in FIG. 24. The casino personnel then may compare the photo identification appearing on the screen shown in FIG. 27 with the appearance of the person who inscribed the signature shown in FIG. 24 and may compare the signature so inscribed with the signature on file with the casino. Again, by touching the screen above the “cancel” field, work flow will be terminated, and the home screen shown in FIG. 14 can reappear. By touching the screen above the “continue” field, the screen shown in FIG. 27 can appear. Naturally, if the photo appearing on the screen in FIG. 27 does not match the appearance of the person who inscribed the signature appearing on screen 24 or the signatures do not match, then the casino personnel will not continue with the transaction and will seek guidance from other casino personnel, including casino security personnel.

It is also contemplated that the mobile device 710 may be equipped with a camera by which the casino personnel may take a digital photograph of the patron who is requesting the marker, which photograph may be digitally stored with the patron's signature created in the screen in FIG. 24.

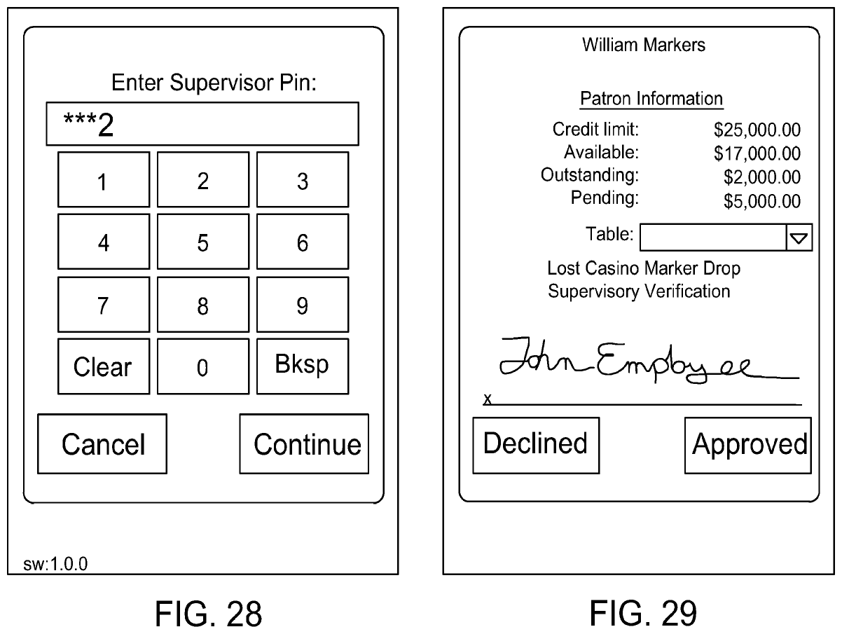

If the screen shown in FIG. 27 reveals no inconsistencies with the appearance of the patron or with the signature of the patron, the screen is touched above the “continue” field in FIG. 27, and the screen shown in FIG. 28 appears. The casino personnel that entered his employee identification number in the field shown in FIG. 26 then enters his casino personnel's PIN number in a similar manner in all respects to that described with reference to the screen shown in FIG. 26.

When the user touches the screen above the “continue” field shown in FIG. 28, the screen shown in FIG. 29 can appear, which screen includes information about the patron's account such as the credit or funds available, how much has been used, how much remains, and the amount of the pending marker request. The screen may also display a selection of tables or other locations in the casino where the patron or the casino personnel is located, and the user then selects the appropriate table or other location from the available menu or table. Finally, the casino personnel utilizes the plastic pen, their finger, or other implement to inscribe the casino personnel's signature in a signature field of the display in a manner similar to that described with reference to FIG. 24. Alternatively, the mobile device 710 may be associated with a particular table or location in the casino or a particular casino personnel, in which situation, the display screen shown on FIG. 29 will not show a menu or table.

The screen in FIG. 29 may also display any limitations or warnings such as that the patron is requesting a marker over an aggregate amount within a predetermined time interval or that the marker is being requested at an undesired location in the casino. These warnings may help restrain a patron in a manner previously desired by the patron so that the patron does not wager excessively on compulsion or may avoid marker requests from being made at time intervals and at locations where it would be physically impossible or impractical to be legitimately made by the patron. Instead of a warning, the system 700 may be programmed to prohibit the completion of the marker request.

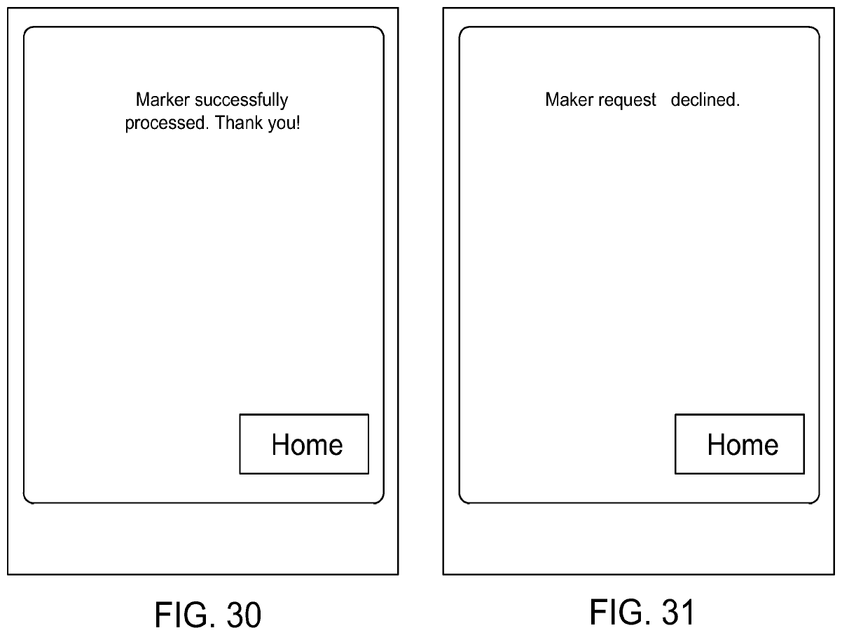

Based on the information in the display screen shown in FIG. 29, the casino personnel may decide to decline the marker request, and if so, will touch the screen above the “decline” field, whereupon the screen shown in FIG. 31 can appear. The casino personnel then will orally notify the patron and possibly other casino personnel, such as a dealer, that the marker request has been declined. Thereafter, the casino personnel will touch the screen above the “home” field, which can cause the home screen shown in FIG. 14 to reappear. The casino personnel may then return the mobile device 710 to its charging and storage base or to another designated location. Alternatively, the casino personnel may touch the screen above the “approved” field, which can cause the screen shown in FIG. 30 to appear. The casino personnel may then orally notify the patron that the marker request has been approved, and may possibly notify other casino personnel, such as the dealer, that the marker request has been approved. Thereafter the casino personnel touches the screen above the “home” field, the work flow is completed, and the mobile device 710 is returned to the charging and storage base 716 or to some other designated location.

The process of redeeming a marker in accordance with an example embodiment of the present disclosure will now be described.

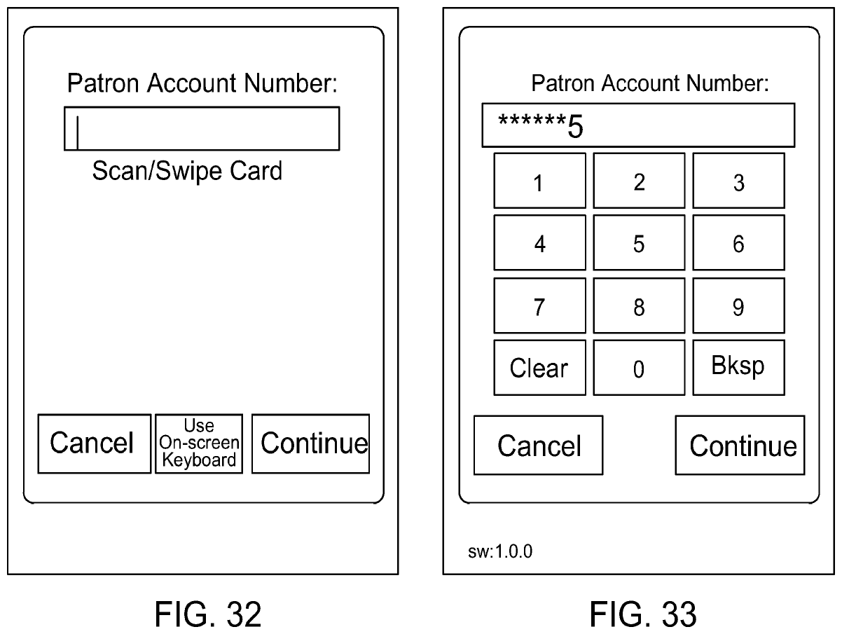

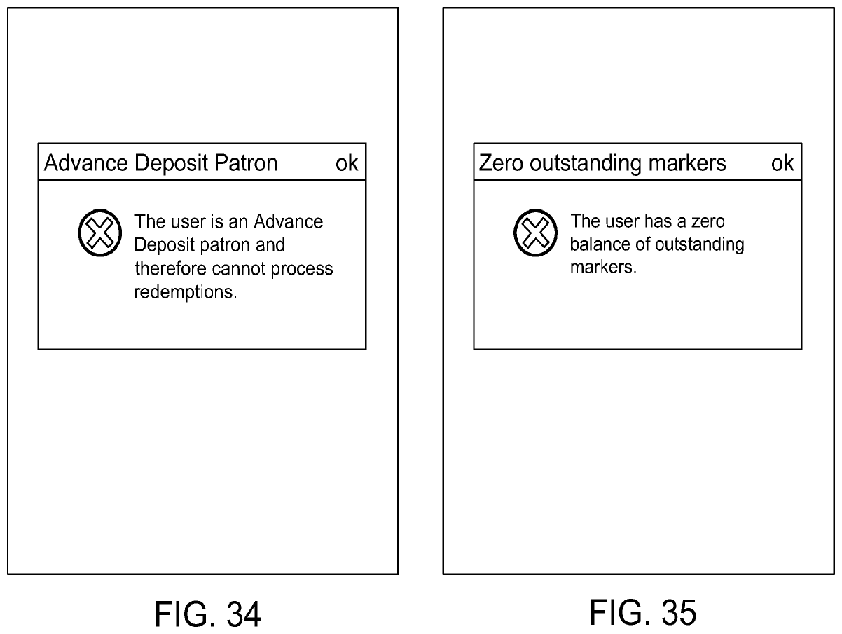

A user views the home page shown in FIG. 14 and touches the screen above the “redeem” field, which causes the mobile device 710 to display the screen shown in FIG. 32. The user then enters the patron account number in the same manner as described in reference to the screen shown in FIG. 15. When the screen is touched above the field “use on-screen keypad”, the screen shown in FIG. 33 will appear. The user may then use the keypad to enter the patron account number in a manner similar to that described with reference to the screen shown in FIG. 16. If the system 700 determines that the patron account number entered corresponds to an advance deposit account, rather than a credit account, the mobile device 710 can display the screen shown in FIG. 34. Casino personnel may then inform the patron that the marker cannot be redeemed because the patron account number corresponds with a deposit account, rather than a credit line. The patron may then be asked if the patron has a different patron account number. The user of the mobile device 710 then touches the screen above the “ok” field, which terminates the work flow and causes the mobile device 710 to display the home screen shown in FIG. 14.

If the system 700 determines that the patron has no outstanding markers awaiting redemption, the mobile device 710 can display the screen shown in FIG. 35. Again, casino personnel may inform the patron that there are no outstanding markers associated with that patron account number. Casino personnel may then touch the screen above the “ok” field, which will cause the mobile device 710 to display the home screen shown in FIG. 14.

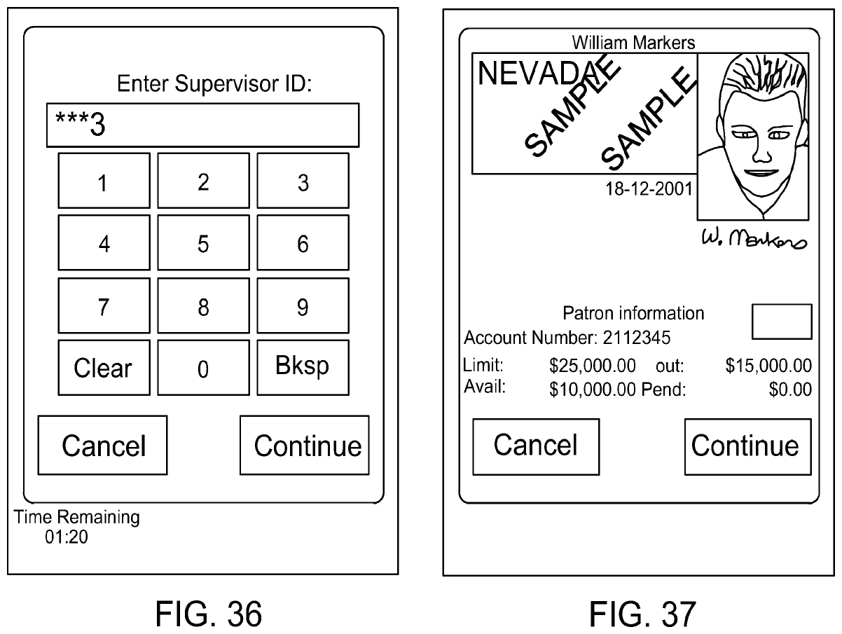

If the system 700 determines that there are one or more outstanding markers awaiting redemption in the patron account number, then the mobile device 710 can display the screen shown in FIG. 36. Casino personnel, such as the pit boss, then enters his employee identification number in a manner similar to that shown described with reference to FIG. 26. The screen shown in FIG. 36 can also be associated with a limited, predetermined time for completing the employee identification number and may display the time remaining to complete the employee identification number in a manner similar to that described with reference to the display screen shown in FIG. 15.

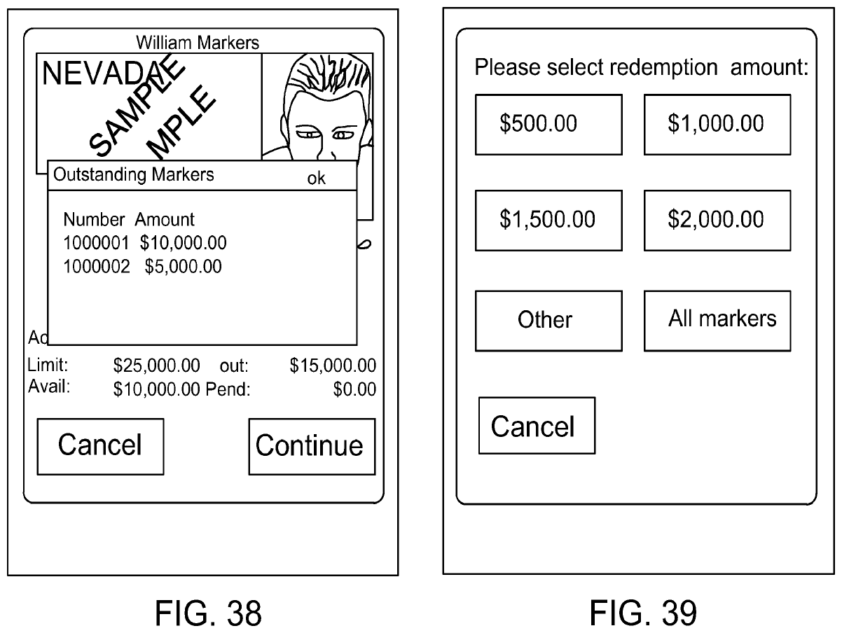

When a user touches the screen above the “continue” field shown in FIG. 36 after having entered an employee identification number recognized by the system 700, then the mobile device 710 displays the screen shown in FIG. 37. The screen displays a photo identification of the patron associated with the patron account number entered in a screen shown in FIG. 32 so that the casino personnel may verify that the patron requesting the redemption is the same person associated with the patron account number. The screen may also display the account number, the total amount of the credit line, the amount of credit remaining, any pending requests for markers, and the currently outstanding amount of credit. The screen may also display a field designated “outstanding markers”. By touching the screen above the “outstanding markers” field, the screen shown in FIG. 38 will appear, which will indicate the different markers by number in the amount of each such marker. If the screen has been touched above the “outstanding markers” field, and the screen display shown in FIG. 38 appears, then the casino personnel may cause the screen shown in FIG. 37 to reappear by touching the screen above the “ok” field shown in FIG. 38.

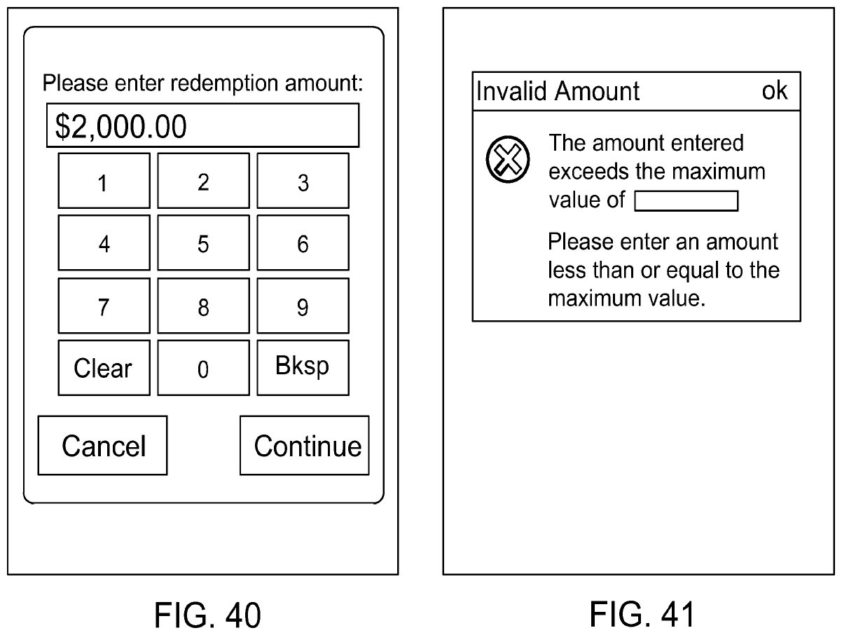

Once the casino personnel verifies that the patron requesting the redemption is the same person whose photo appears on the screen shown in FIG. 37, the user touches the screen above the “continue” field shown in FIG. 37, which causes the screen shown in FIG. 39 appear. It will be appreciated that the screen shown in FIG. 39 is very similar to the screen shown in FIG. 19, and is implemented in a manner similar to that described with reference to FIG. 19. If the patron wants to select an amount other than a fixed, predetermined amount shown on the screen depicted in FIG. 39, then the user touches the screen above the “other” field, which will cause the screen shown in FIG. 40. It will be appreciated that the screen shown in FIG. 40 is very similar to the screen shown in FIG. 20, and the screen functions in a manner similar to that described with reference to FIG. 20. If the amount selected exceeds the amount of the credit used, then the screen shown in FIG. 41 will appear, which indicates that the amount selected exceeds the amount of outstanding credit and that the patron should select a lower amount. If the screen shown in FIG. 41 appears, the user may touch the screen above the “ok” field, which will cause the screen display shown in FIG. 39 to reappear, and the process of selecting an amount of the redemption is repeated.

In accordance with one embodiment, any amount selected as the redemption amount is first automatically applied against the oldest outstanding markers.

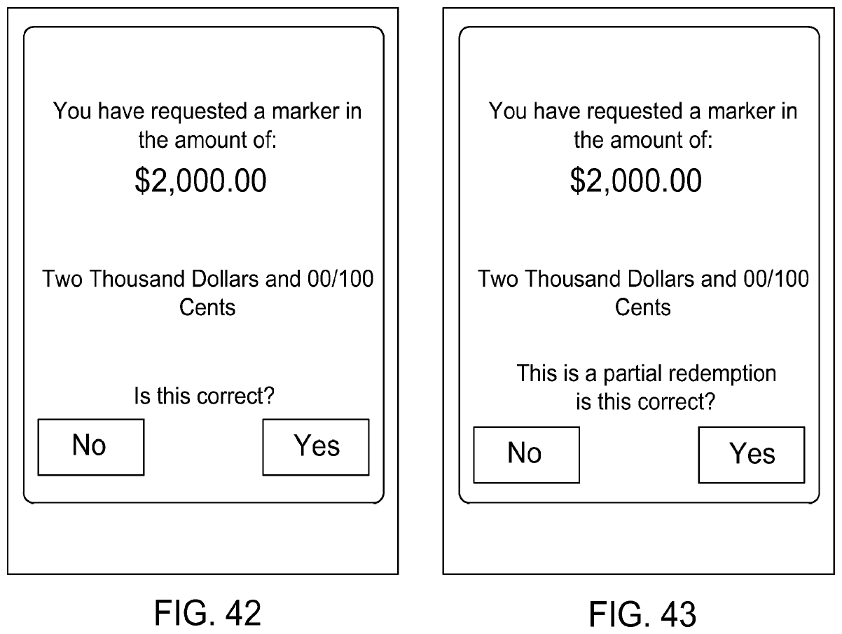

When an appropriate value that is less than or equal to the outstanding credit has been selected, either the screen shown in FIG. 42 or in 43 will appear, depending on whether the redemption is for the entire amount of the credit outstanding or for only a partial amount of the credit outstanding, respectively. If the amount or nature of the redemption is incorrect or if the patron decides not to continue with redemption, then the user touches the screen above the “no” field shown in either FIG. 42 or 43, and the work flow will terminate, and the home screen shown in FIG. 14 will reappear.

If the patron agrees with the amount and nature of the redemption, then the user touches the screen over the “yes” field as shown in either FIG. 42 or 43. Thereafter, the mobile device 710 can display series of screens in all respects similar to those shown in FIGS. 23, 24, 25, and which are completed similarly to those described above with reference to FIGS. 23-28. Such a process helps to insure that the patron redeeming the marker is the same as the patron associated with the patron account number and provides an electronically stored record of the patron's commitment to making the redemption.

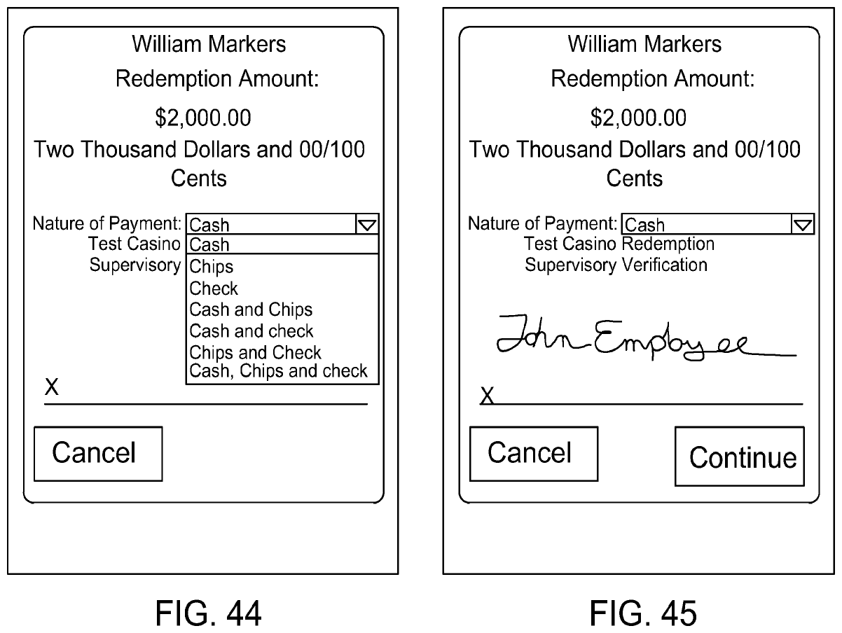

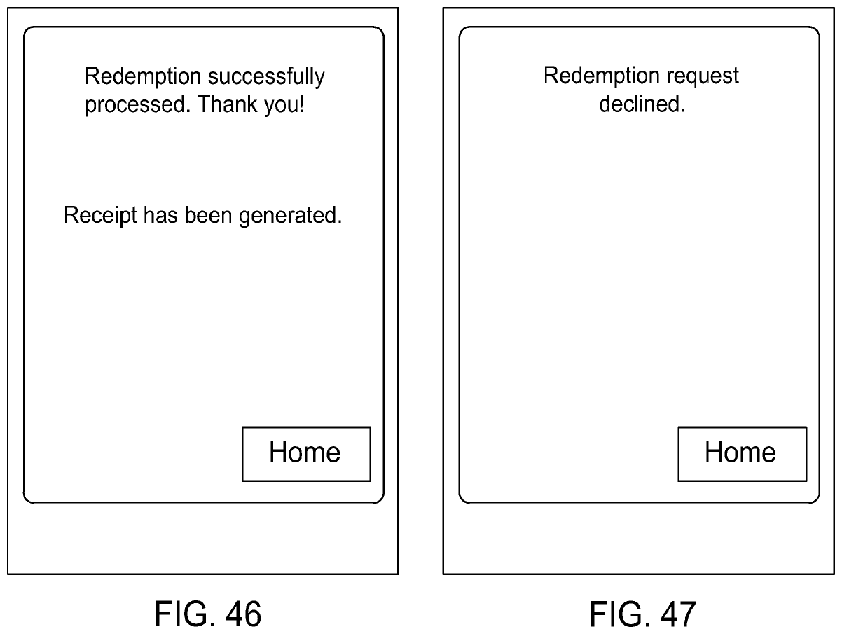

Thereafter, the screen shown in FIG. 44 is displayed on the mobile device 710. That screen displays the patron's name, the amount of the redemption, and a menu or table of the manner in which the redemption will be paid, such as with cash, casino chips, or a bank check, or a combination of thereof. The casino personnel selects the appropriate method of payment from the menu or table, but also has the option of choosing to touch the screen above the “cancel” field, which will terminate the work flow and cause the home page shown in FIG. 14 to reappear. If the casino personnel wishes to continue with the redemption transaction, then the casino personnel inscribes his signature in much the same way as previously described with reference to FIG. 29 whereupon the screen will display FIG. 45. Casino personnel may touch the screen above the “cancel” field which will terminate work flow and cause the mobile device 710 to cause the home screen shown in FIG. 14 to reappear. Alternatively, the casino personnel may touch the screen above the “continue” field when it appears, which will cause either the screen shown in FIG. 46 or the screen shown in FIG. 47 to appear.

In any of the foregoing transactions involving the displays, if a patron account number, a patron PIN number, a casino personnel employee identification number, or a casino employee PIN number are invalid or otherwise not contained in the database included in the system 700, then a screen may appear to notify the user of the mobile device 710 that such numbers or PINs are invalid or cannot be found. Also, if the communication link between the mobile device 710 and the rest of the system 700 is disconnected, the mobile device 710 may cause a screen to display a “communication error” message, which will either prompt the user to wait or will return the user to the home screen shown in FIG. 14, or will suggest that the user check the status of the batteries in the mobile device 710.

At least some, and in some embodiments all, of the images appearing on the mobile device 710 are digitally stored at least until the marker has been paid or redeemed in full, such as through an EFT or an ACH. Evidence of the payment or redemption transaction can also be digitally stored. The storage of the images and of the transaction evidence may be stored for as long as desired or mandated. For instance, the casino itself may be a policy to store such, records for a period of time by which any applicable statute of limitations might expire or for a period of time dictated by tax authorities, or the casino may be obligated to store such records for a period of time required by applicable gaming regulations.

While the previous embodiments generally relate to a credit instrument (referred to a marker) being executed contemporaneously with the advancement of funds to a patron, this disclosure is not so limited. In some embodiments, for example, extensions of funds can be advanced to a patron on credit and prior to the issuance of a marker, thereby allowing a patron to “play on the rim.” Rim play can be a courtesy extended to high level, fast betting casino patrons, for example. Such extension of funds during gameplay and prior to the issuance of a marker is sometimes referred to as “rim play”. As described in more detail below, at the end of the gameplay, the total amount of funds extended (less any repayment by the patron at the table) can be converted to casino marker.

During rim play in accordance with the present disclosure, each extension of funds provided to a patron can be validated, tracked, and logged in real-time through inputs to one or more mobile devices on the casino floor. Such extensions of funds can beneficially be provided during gameplay, while the patron is in action, thereby allowing the patron to game without interrupting play to obtain an executed marker. Through the use of the mobile devices and associated computing systems and methodologies described herein, various benefits can be realized for both the patron and the casino operator. The chances of bookkeeping errors with regard to extensions of funds are beneficially decreased. Additionally, prior to each extension of funds, the amount of real-time available credit for the patron is queried and the extension of funds will only be approved if the extension of funds will not exceed the available credit line of the patron. This aspect is particularly beneficial when patrons move table to table, sometimes in relatively short timeframes, and request rim play at multiple tables. Thus, the ability for casino personnel to inadvertently provide a patron with an extension of funds that exceeds their approved credit line is eliminated, even if the patron is rapidly moving between multiple tables during gameplay.

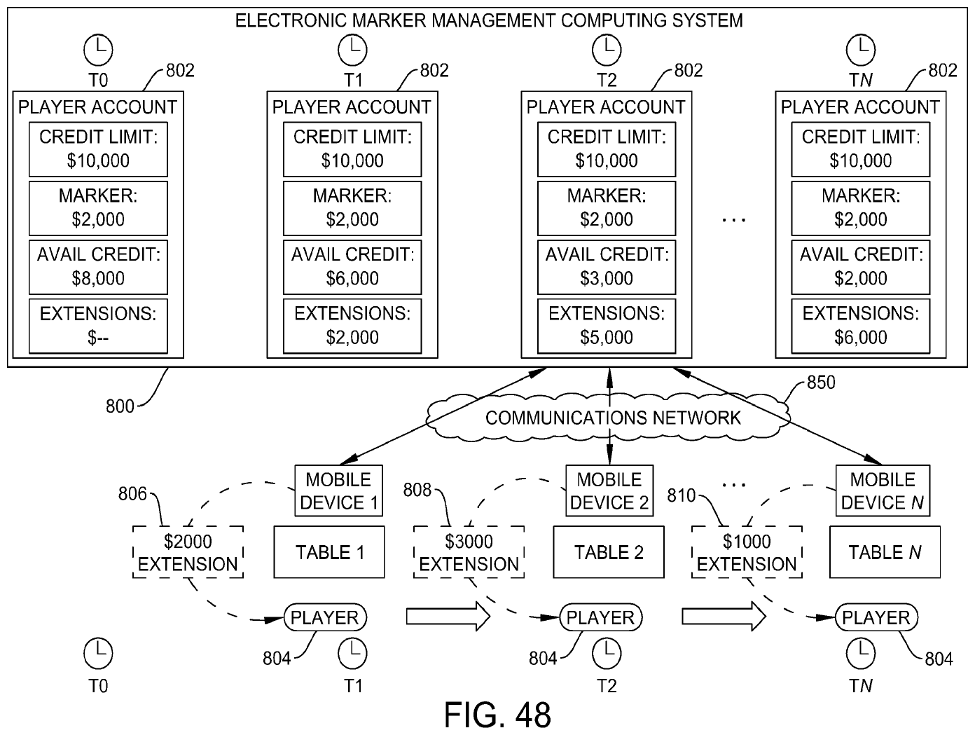

Referring now to FIG. 48, the provisioning of multiple extensions of funds to a player over time is schematically depicted in accordance with one non-limiting embodiment. FIG. 48 illustrates a plurality of gaming tables, shown as Tables 1-N, and in this example embodiment, each table is associated with a mobile device. In some embodiments, the mobile devices can be similar to the mobile device 710, described above. Further, while FIG. 28 illustrates a 1:1 correspondence between gaming tables and mobile devices, it is to be appreciated that this disclosure is not so limited. Instead, a single mobile device can service multiple gaming tables, such as a grouping of gaming tables in close proximity to one another (i.e., one mobile device per pit). The mobile devices 1-N are shown to be in networked connection with a centralized electronic marker management computing system 800, which can be similar to the system of FIG. 7, for example.

As is schematically shown, the electronic marker management computing system 800 can manage a player account 802 for the player. The electronic marker management computing system 800 can be implemented as specialized a web and services application that services support both the web and mobile applications, for example. Mobile devices can access the electronic marker management computing system 800 services via a secure, wireless network 850. As a web application, the electronic marker management computing system 800 can be accessed via a web browser from an authorized user's computer. In this regard, authorized users, validated by username and password, can access job/role-appropriate application features using a web browser.

The player account 802 can track, for example, multiple parameters, ledgers, or other aspects of a particular patron. At TO, for example, the player account 802 is shown to have a credit limit of $10,000, an executed marker of $2,000, and an available credit line of $8,000. At T 1, the player is shown playing at Table 1. Through interactions with a mobile device 1, the player requests a $2000 extension of funds. Upon approval by the electronic marker management computing system 800, the player receives $2,000 worth of chips for gameplay. As a result of the $2,000 extension of funds, the player account at T1 now reflects the available credit has decreased to $6,000 and the $2,000 extension is logged. As shown in FIG. 48, at T2 the player has moved to Table 2. At Table 2 an extension of $3,000 is requested, and upon approval by the electronic marker management computing system 800, the dealer is instructed to provide the player with $3,000 worth of chips. As a result of the $3,000 extension of funds, the player account at T2 now reflects the available credit has decreased to $3,000 and the $3,000 extension is logged to increase to total about of extensions to $5,000. At TN the player has moved to Table N. At Table N an extension of $1,000 is requested, and upon approval by the electronic marker management computing system 800, the dealer is instructed to provide the player with $1,000 worth of chips. As a result of the $1,000 extension of funds, the player account at TN now reflects the available credit has decreased to $2,000 and the $1,000 extension is logged to increase to total about of extensions to $6,000. As the amount of available credit is tracked in real-time, which is based on the player's available credit limit, total marker amount, and total extension amount, the centralized electronic marker management computing system 800 can ensure the player is not extended funds during Rim play that would allow the player to exceed their overcall credit limit. As illustrated in FIG. 48, this aspect is especially beneficial if the player is switching between multiple tables.

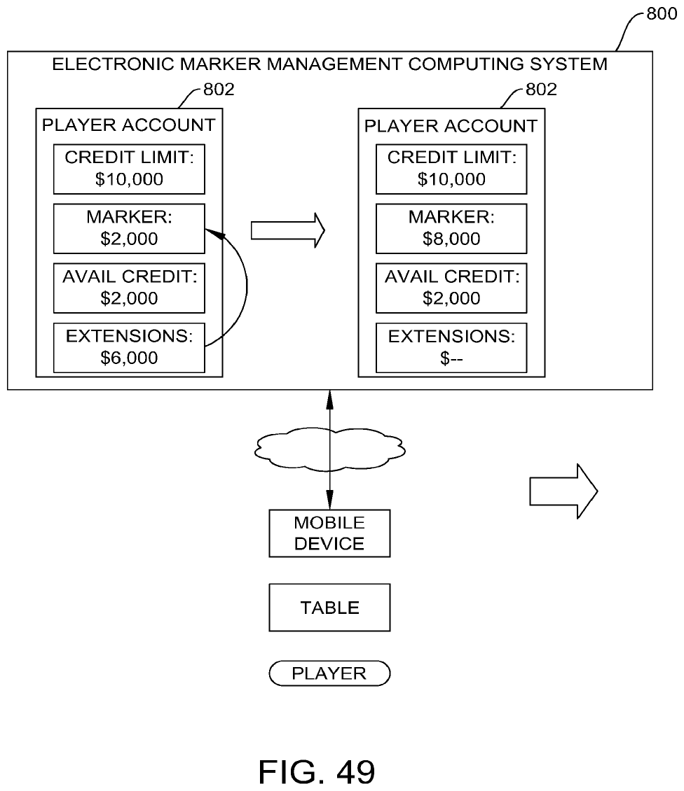

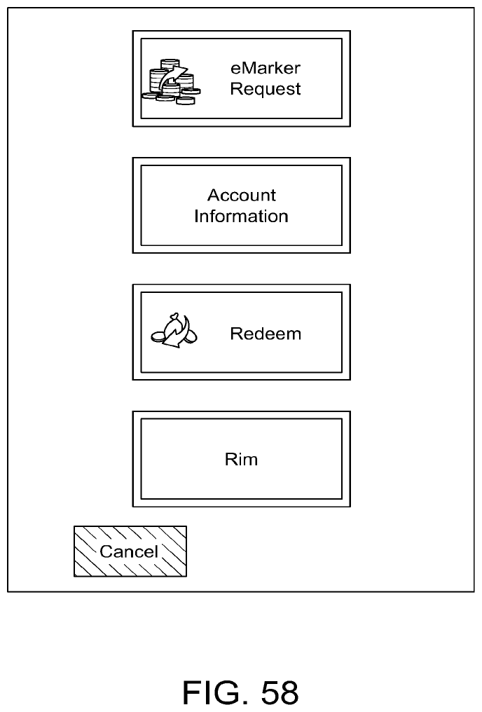

Referring now to FIG. 49, an issuance of a marker to the player based on the amount of funds extended to the player during gameplay is schematically depicted. In this embodiment, the player has provided instructions, such as via inputs to the mobile device, to convert the full amount of their fund extensions to a marker. As such, the value of their extensions drops from $6,000 down to zero and the total amount of the marker issued to the player increases from $2,000 to $8,000. Examples of the screens presented on the interface of the mobile device during such a transaction are provided below with reference to FIGS. 58-72.

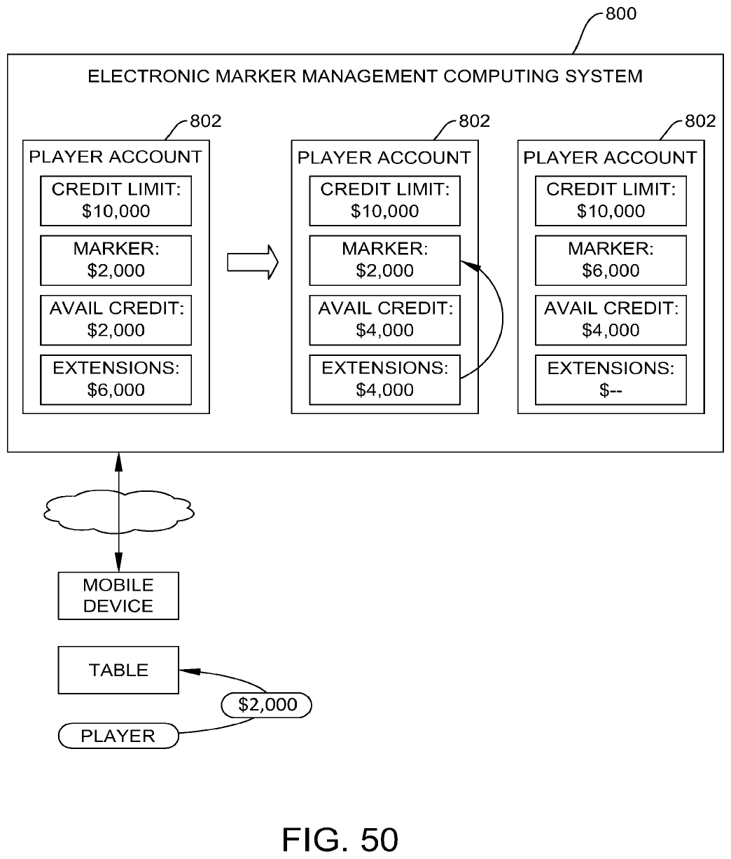

Referring now to FIG. 50, an issuance of a marker to the player based on a partial amount of funds extended to the player during gameplay is schematically depicted. In this embodiment, prior to converting the extension of funds to a marker, a portion of the extension is repaid by the player. As shown, the player tenders a payment of $2,000, which can be in any suitable form (cash, chips, voucher ticket, and so forth). The payment of $2,000 by the player reduces the amount of outstanding extensions to $4,000 which can be converted to an electronic marker. As such, the total amount of the marker extended to the player in FIG. 50 is $6,000.

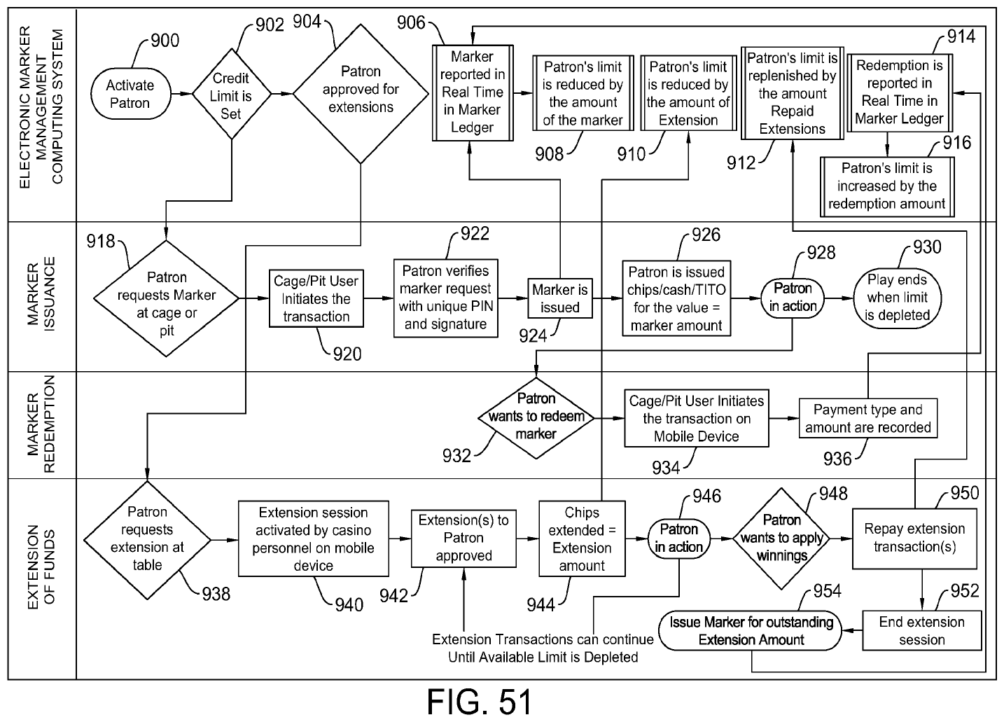

FIG. 51 is a flow chart depicting example processes of an electronic marker management computing system facilitating the issuance of a marker, the redemption of a marker, and extension of funds to a patron, in accordance with one non-limiting embodiment. At 900, a patron account is activated within the electronic marker management computing system. The electronic marker management computing system can be similar to, for example, the electronic marker management computing system 800 described above. At 902 a credit limit can be set for the patron. Such credit limit can be determined via any suitable approach or technique, such as querying the patron's credit score, determine the amount of credit previously extended to the patron at other properties, income level, and so forth. Once the credit limit has been set for the patron, at 904 it can be determined whether the patron is approved for extensions. Such determination can be based on, for example, a loyalty status of the patron, the gaming profile of the patron, their credit history, and/or other factors so forth.

Subsequent to the activation of the patron account, an electronic marker can be requested at 918. Such marker can be requested at any suitable location, such as at a cashier's cage or at a table (i.e., pit). At 920, casino personnel can initiate the marker transaction, such as using a mobile device in accordance with the present disclosure. At 922, the patron verifies the marker request through interactions with the mobile device using a unique PIN and a signature, or any other suitable verification technique (such as biometrics, etc.). Upon successful verification, a marker is issued to the patron at 924, with such issuance being logged into a marker ledger of the electronic marker management computing system in real-time at 906.

Additionally, based on the issuance of this marker, the patron's available credit can be reduced by the amount of the marker at 908. At 926, the patron is issued value in an amount equal to the maker in any suitable form, such as via chips, cash, or a redeemable voucher (such as a “TITO” ticket), for example, and at 928 the patron uses such value for gaming. In some cases, the patron will continue to gameplay until all of the funds are depleted, as shown at 930, at which point the marker extended to the patron will remain outstanding.

When the patron wants to redeem the marker, as shown at 932, the patron can do so at any suitable location, such as at the cashier cage or at a table, for example. At 934, the casino user can interact with the mobile device to initiate the transaction and at 936 the payment type and amount are recorded into the mobile device. Such mobile device can communicate with the electronic marker management computing system through secure networked communications so that the redemption of the marker can be recorded into the marker ledger for the patron in real-time at 914. Based on the redemption of the maker, the patron's available credit can be increased by the redemption amount at 916.

Referring now to 938, a patron requests an extension at a table (sometimes referred to as a “Rim Out” transaction). At 940, casino personnel can interact with a mobile device to activate an extension session for the player. In accordance with the present disclosure, if the amount of funds requested in the extension does not exceed the patron's available credit limit, the extension to the patron is approved at 942. At 944, chips are extended to the patron from the dealer's rack and at 946, the patron is in action. Additionally, as indicated at 910, the patron's available credit is simultaneously reduced by the amount of the extension. As indicated in FIG. 51, extensions transactions to the patron can continue if the patron continues to have available credit. Each extension is logged in the electronic marker management computing system, including extensions for the patron that may occur at different tables, as described above.

At 948, the patron wishes to apply winnings against part of the extension amount. Through interactions with the mobile device, casino personnel can indicate the repayment amount tendered by the patron at 950. At 912, the patron's available credit is replenished by the amount of the extension that was repaid. At 952, the patron desires to end the extension session. At 954, an electronic marker in the amount of any remaining extension of funds can be issued to the patron.

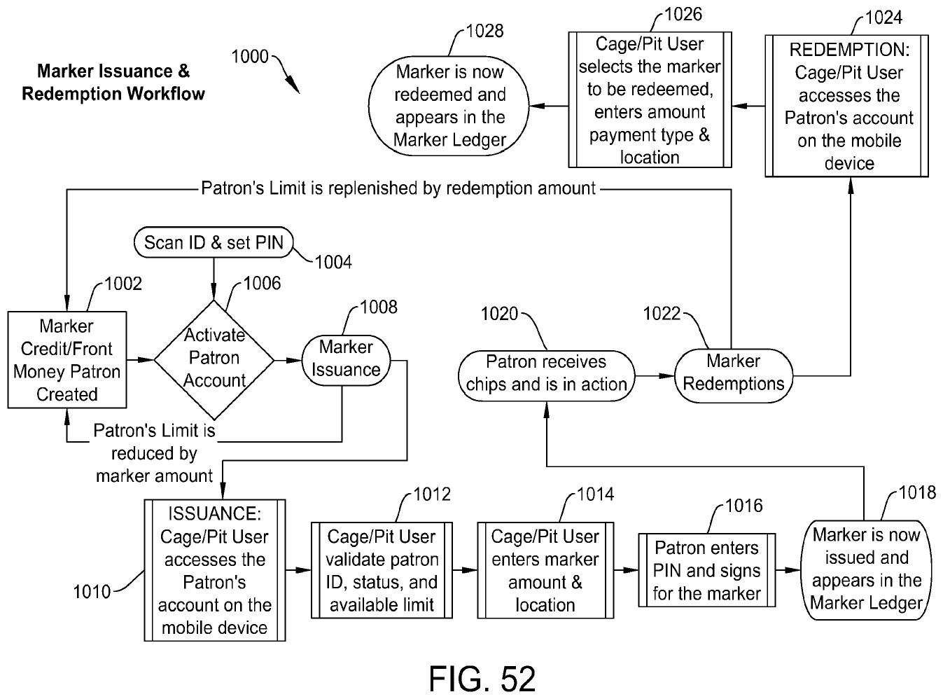

Referring now to FIG. 52, an example marker issuance and redemption workflow 1000 in accordance with one example embodiment is illustrated. At 1002, a credit limit for a patron is established and at 1006 the account goes through an activation process, which can include various enrollment processes. As shown in FIG. 52, such enrollment processes can include scanning an identification document of the patron (such as a driver license) and setting a PIN number for the patron at 1004. An electronic marker can be issued to the patron at 1008, which also serves to reduce the patron's available credit limit by the amount of the maker. The issuance of the marker can include a variety of sub-steps, as shown in FIG. 52 at 1010 through 1018. At 1010, the casino personnel can access the patron's account via a mobile device. At 1012, the casino personnel can validate the patron's ID, loyalty status, and available credit via the mobile device. At 1014, the casino personnel provide can details regarding the marker, such as the amount of the marker and the location at which the marker was issued. At 1016, the patron can enter their PIN and sign for the marker via interactions with the mobile device. At 1018, the marker is issued and simultaneously appears in the marker ledger for the patron. The patron can receive chips at 1020 in an amount corresponding to the marker and use them to participate in gameplay.

Subsequently, the patron can perform a marker redemption at 1022, which serves to increase their available credit amount by the redemption amount. The redemption process can include a variety of sub-steps, as shown in FIN. 52 at 1024 through 1028. At 1024, the casino personnel can access the patron's account on a mobile device. At 1026, the casino personnel can select the particular marker to be redeemed, enter the payment amount tendered by the patron, and the location. At 1028, the marker is redeemed and the redemption is logged into the marker ledger.

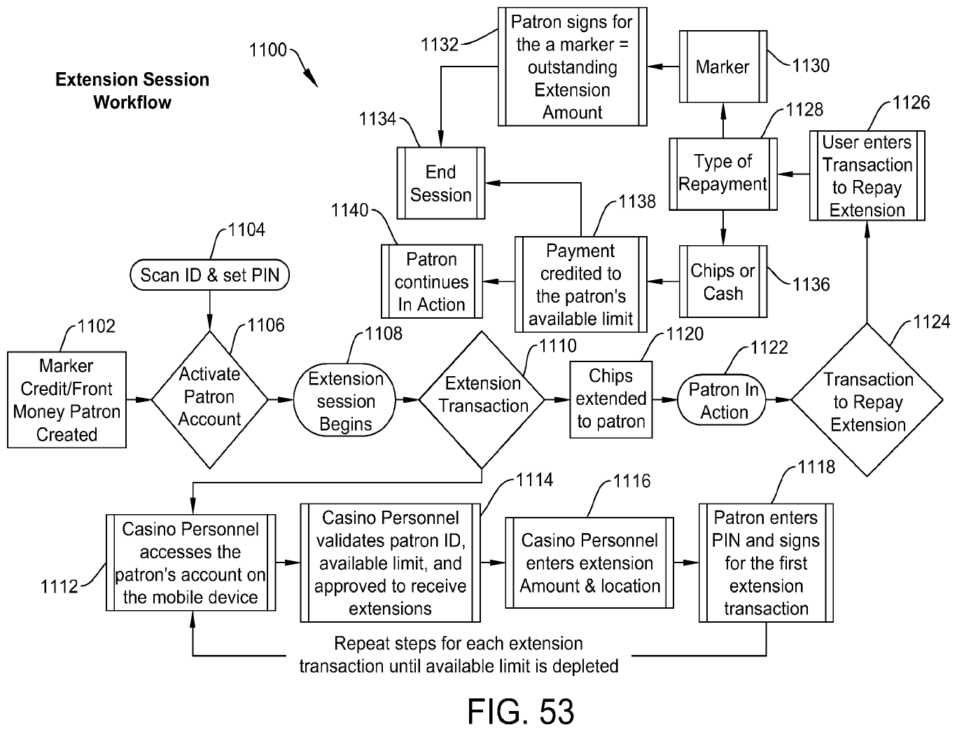

Referring now to FIG. 53, an example extension session workflow 1100 in accordance with one example embodiment is illustrated. At 1102, a credit limit for a patron is established and at 1106 the account goes through an activation process, which can include various enrollment processes. As shown in FIG. 53, such enrollment processes can include scanning an identification document of the patron (such as a driver license) and setting a PIN number for the patron at 1104. An extension session can begin at 1108, such as when the patron requests an extension of funds while gaming at a table. An extension transaction can be initiated using a mobile device at 1110. The extension transaction can include a variety of sub-steps, as shown in FIG. 53 at 1112 through 1118. At 1112, the casino personnel can access the patron's account on a mobile device. At 1114, the casino personnel can utilize the mobile device to validate the patron ID, the available credit limit, and whether the patron is approved to receive extensions. At 1116, the casino personnel then can enter the amount of extension and the location at which the extension is provided to the patron. At 1118, the patron can enter their PIN (or other authentication input) and sign the mobile device for their extension. As shown in FIG. 53, sub-steps 1112-1118 can be repeated at the same location, or two or more different locations, until the patron has depleted their available credit limit.

Based on the validated and confirm extension transaction, chips can be extended to the patron 1120 so that the patron can continue to gameplay at 1112. Subsequently, at 1124, the patron can begin a transaction to repay the extension at 1124 (sometimes referred to as a “Rim In” transaction). The transaction to repay the extension can include a variety of sub-steps, as shown in FIG. 53 at 1126 through 1134. At 1126, the casino personnel interacts with a mobile device to begin the transaction to repay the extension. At 1128, the type of repayment from the patron is entered. In some embodiments, the patron can decide whether to receive a marker or repay the extension using chips or cash. If the patron wishes to receive an electronic marker, as indicated at 1130, the patron can sign at 1132 for a marker that is equal to the amount of outstanding extensions. The session then ends at 1134. If the patron wishes to repay using cash or chips, as indicated at 1136, the patron can tender payment that is credited towards the patron's available limit at 1138. The patron can continue to gameplay at 1140 or end their gaming session at 1134.

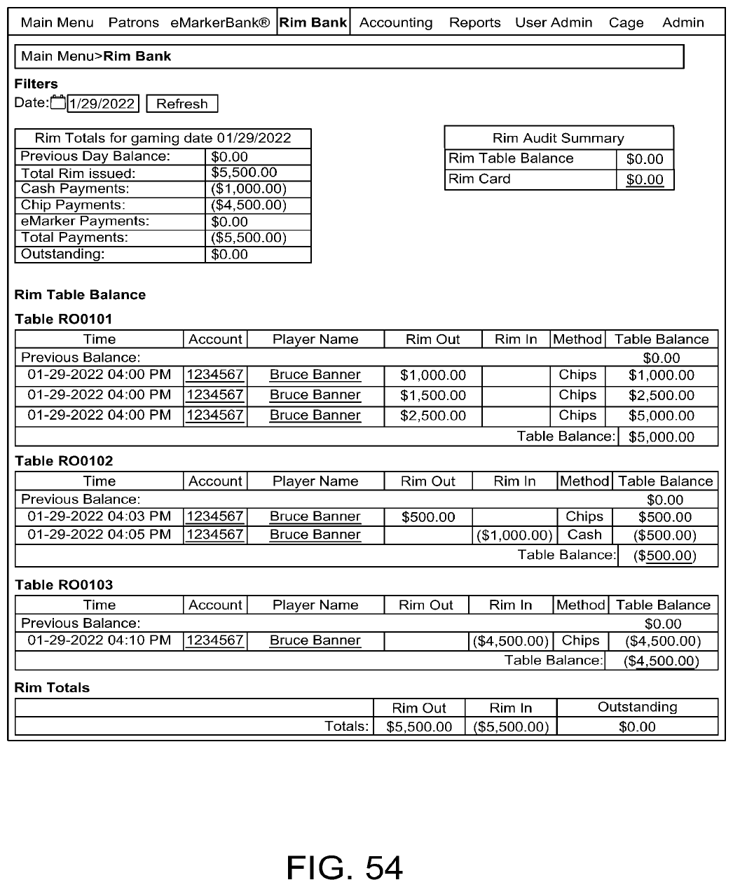

Referring now to FIGS. 54-57, example non-limiting screens provided by an electronic marker management computing system are depicted. Such screens can be provided, for example, to casino personnel interacting with the system via a web interface or via specialized application executing on a computing station. FIG. 54 depicts real-time ledger information for extensions that have been provided on a gaming floor. Totals are shown for the current gaming day and “Rim Out” and “Rim In” transactions can be attached to the table location where they took place. Each table with a Rim balance can appear on the “Rim Bank” with a list of transactions for the gaming day. Beneficially, such view provides for real-time information for a specific player, even if extensions are taken at a number of different tables in rapid fashion. Additional view can be provided such as a Rim Table Balance view that shows a list of each table with Rim Activity in the gaming day. It can show a real-time list of the Rim transactions and a table balance.

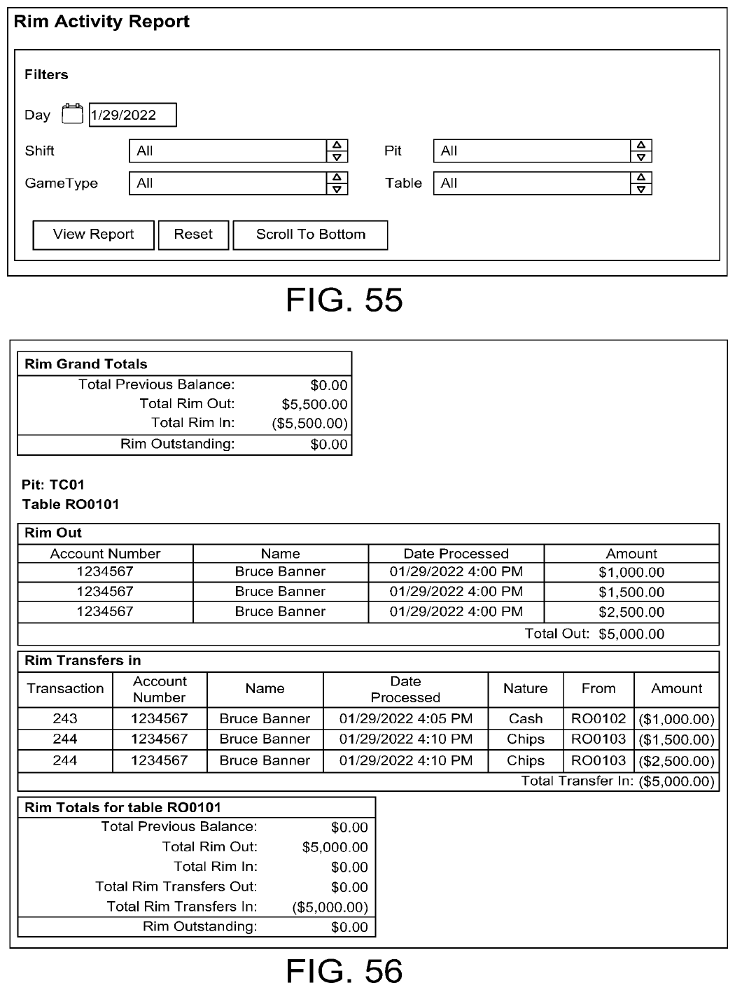

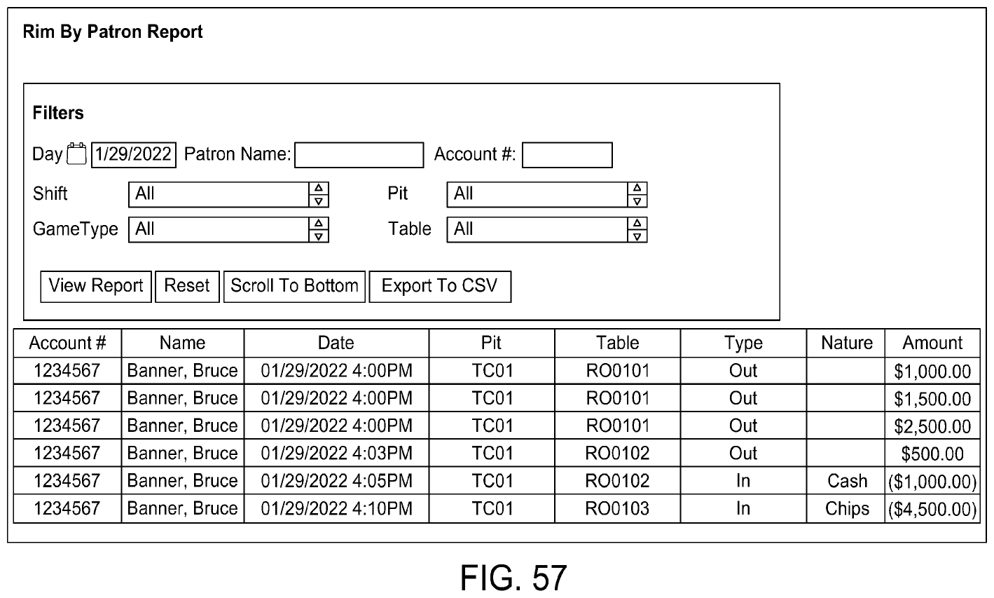

As shown in FIGS. 55-56, a Rim Activity Report can optionally show the Rim Activity per table for a specific gaming day. This information can be filtered, for example, by shift, pit, game type, and table. The report can also show, for example, all Rim Transfers in and out are required for the report period. FIG. 57 depicts an example screen providing a Rim by Patron Report showing the Rim Activity for a particular patron for a specific gaming day. It can be filtered by shift, pit, game type, and table, for example. The report can show all Rim Out and Rim In transactions.

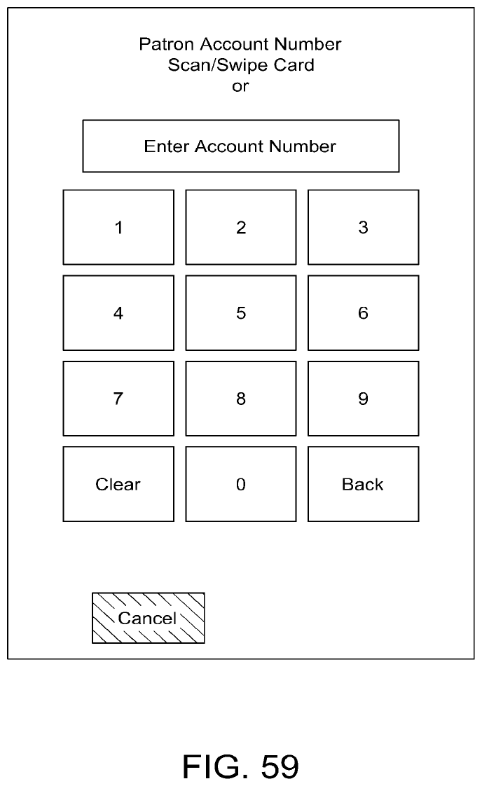

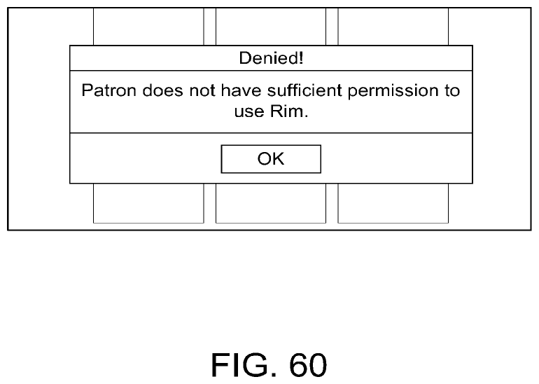

Referring now to FIGS. 58-72, example screens of a mobile device are schematically depicted. As shown in FIG. 58, the Rim option can appear on the action screen of the mobile device when a user with Rim Activity permissions logs into the device. Selecting “Rim” on the action screen can allow the user to enter a Rim Session. Only a patron with the “Allow Rim Play” permission in their account profile will be allowed to have a Rim Session initiated. At FIG. 59, a patron identifier can be provided as an input to the mobile device, such as their loyalty account number. FIG. 60 depicts an example warning screen that can be presented if the patron does not have permission to receive extensions of funds.

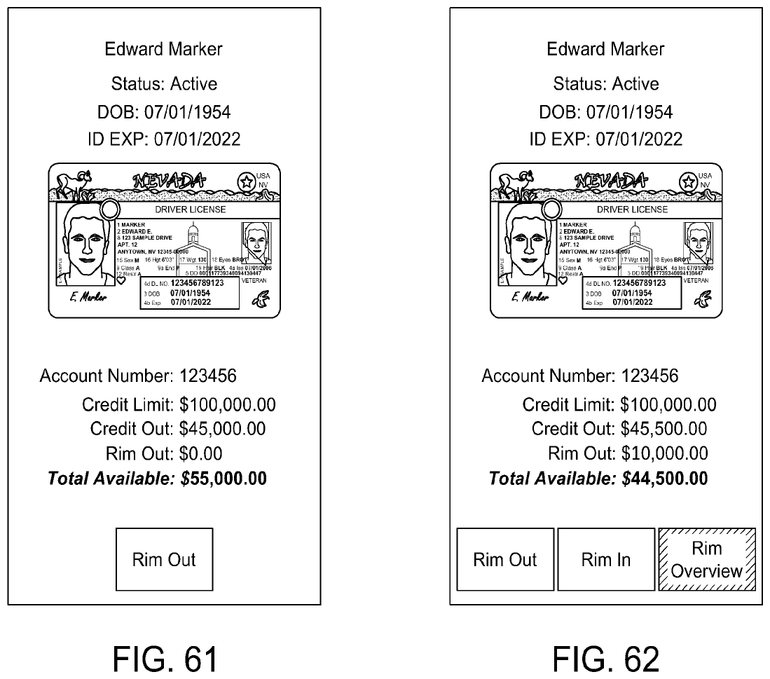

FIGS. 61 and 62 depict screens providing example account profile details of a patron having a $100,000 credit limit. The patron in FIG. 61 has a marker of $45,000 and the patron in FIG. 62 has a marker of $45,500. The patron depicted in FIG. 62, however, has $10,000 in extensions outstanding. As such, the patron in FIG. 61 has a real-time available credit limit of $55,000 and the patron in FIG. 62 has a real-time available credit limit of $44,500. As both patrons have available credit, the “Rim Out” option is presented on both screens.

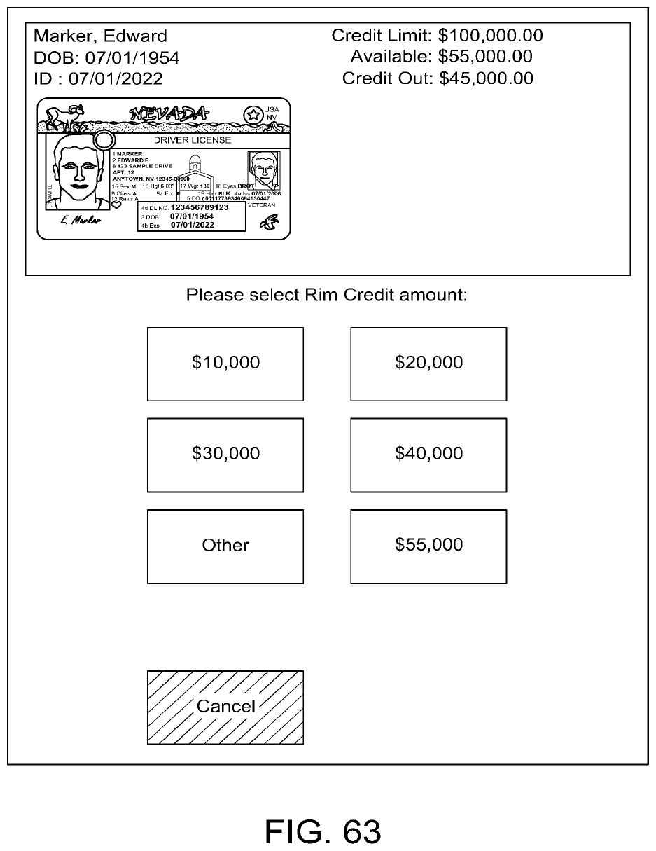

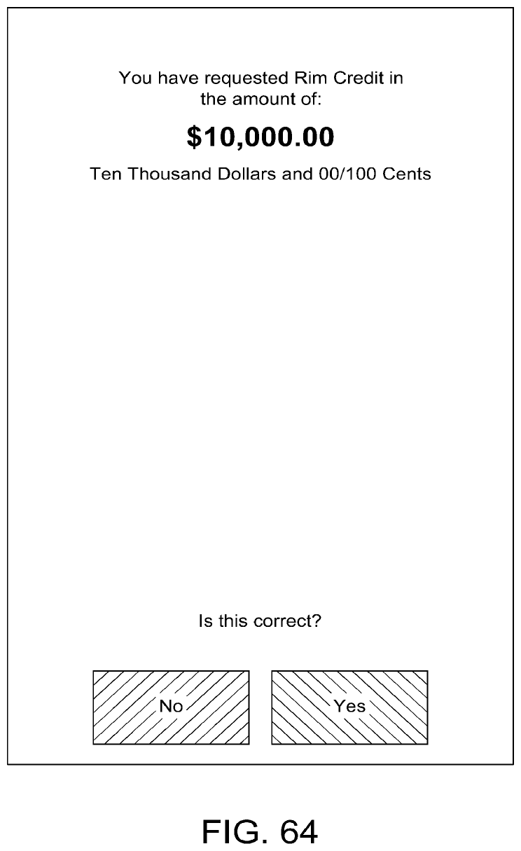

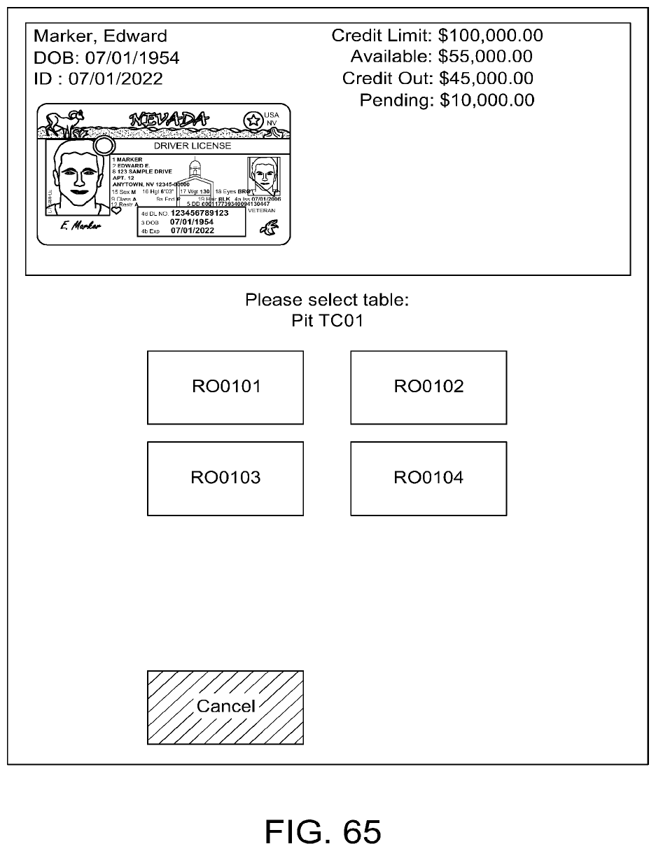

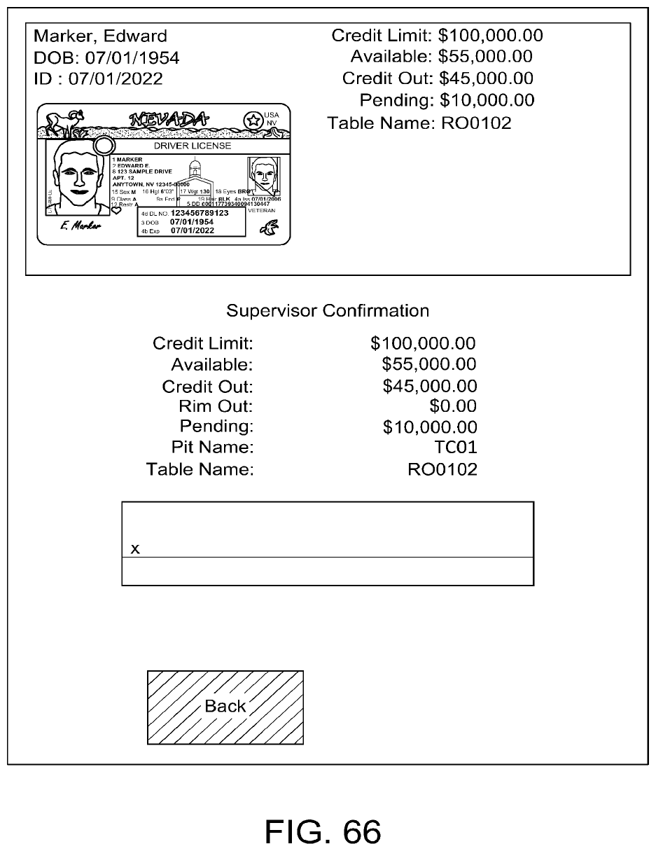

Subsequent to selecting the Rim Out option, the screen of FIG. 63 can be presented. In the example screen depicted in FIG. 63, predefined monetary amounts are provided, as well as an “other” option to allow for a customized, user-specified amount. It is noted that the predefined monetary amounts provided to the user do not exceed the amount of available credit, nor can a user type in an amount that would exceed the amount of the patron's available credit. In the example embodiment, the amount of $10,000 is selected and an example confirmation screen is depicted in FIG. 64 which requires user input. For mobile devices configured to operate in a pit (i.e., in close proximity to a plurality of different gaming tables), the screen presented in FIG. 65 can seek input regarding the table at which the patron is playing, as such information is logged and stored by the electronic marker management computing system. In some embodiments, as shown in FIG. 66, a supervisor can be required to sign the screen of the mobile device, with the screen summarizing the transaction details and providing a patron profile.

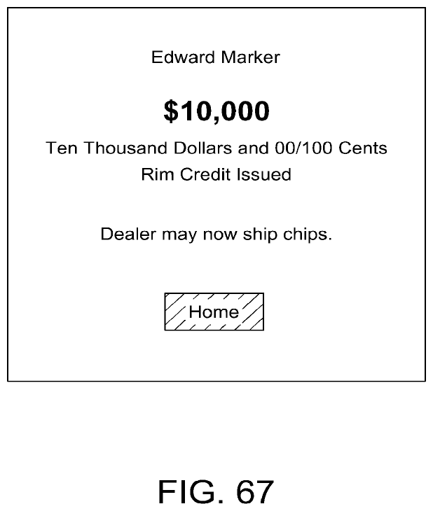

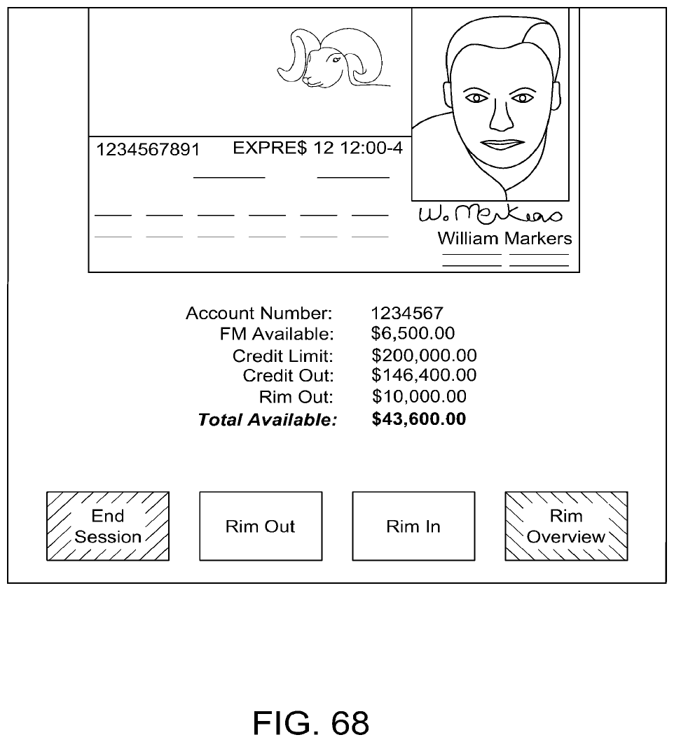

As shown in FIG. 67, a Rim Out completion screen indicates the amount of Rim credit issued and provides approval that the dealer can provide chips to the player in the amount of the extension of funds. The “home” button can then be selected, and the interface of the mobile device can display a Rim Session Home screen shown in FIG. 68 while the Rim Session transpires. Once the patron is selected and the table location is set, the Rim Session can continue until the user chooses to end the Rim Session. During the session, all Rim Out and Rim In transactions are logged in real-time. In some embodiments, if the casino personnel, patron, or table location changes the Rim Session must end. If the patron needs to restart a Rim Session, a new Rim Session can be started, and the existing Rim Outstanding balance will be displayed, and new Rim transactions can be entered. The patron's credit availability can adjust in real-time in both the centralized computing system and as displayed on the mobile device based on Rim Out and Rim In transaction(s).

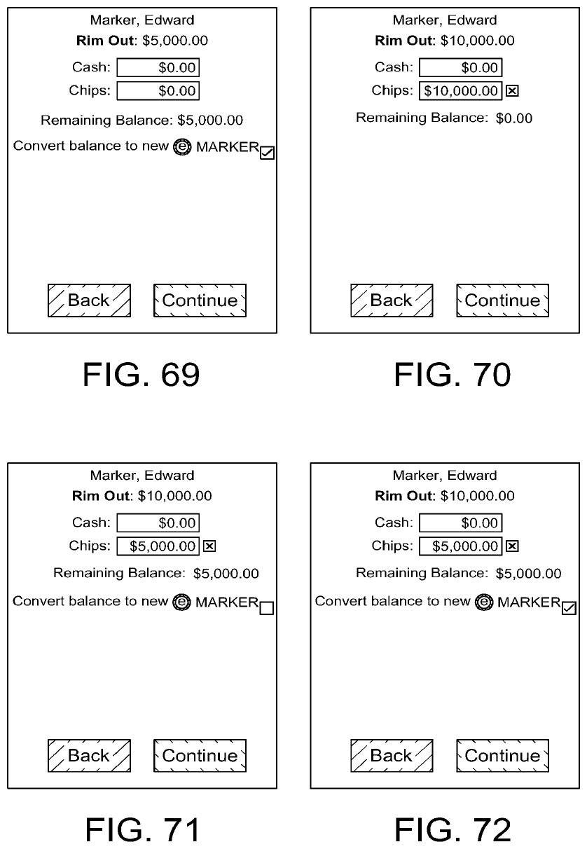

FIGS. 69-72 depict example screens for Rim In transactions in accordance with various non-limiting embodiments. Referring first FIG. 69, the patron has opted to not repay any of the extension, and is therefore converting the entire balance of $5,000 to a $5,000 marker (i.e., a full conversion). In some embodiments, to complete his transaction, a supervisor can select the Convert Balance to new Marker check box and select “Continue.” The supervisor then can confirm the Rim balance amount that will be converted to an electronic marker. The patron can then enter their PIN (or other identifier) and sign for the marker. The supervisor can then enter their PIN (or other identifier) and sign to authorize the transaction. In some embodiments, the dealer will enter their User ID and sign to confirm the transaction. The transaction is then complete, with the Rim Outstanding Balance returned to zero and a marker issued to the patron.

FIG. 70 depicts an example in which the patron elects to repay the entire $10,000 balance with an equivalent amount of chips, thereby reducing the outstanding balance to zero (i.e., pay balance in full). In one example embodiment, the supervisor enters the payment amount in the correct payment type field (cash and/or chips) and selects “Continue.” The Supervisor can confirm the payment amount will fully repay the amount of funds extended and then enter a PIN (or other identifier) and sign to authorize the transaction. In some embodiments, the dealer will enter User ID and sign to confirm the transaction. The transaction is then complete, with the Rim Outstanding Balance returned to zero.

FIG. 71 depicts an example partial payment of the balance by the patron. The supervisor can enter the payment amount in the correct payment type field (cash and/or chips) and select “Continue.” The Supervisor can then confirm the payment amount is a Partial Payment. The supervisor can then enter their PIN (or other identifier) and sign to authorize the transaction. In some embodiments, the dealer will enter User ID and sign to confirm the transaction. The transaction is then complete, with the Rim Outstanding Balance reduced by the partial payment amount.

FIG. 72 depicts an example partial payment of the balance with the remainder converted to a marker. The supervisor can enter the payment amount in the correct payment type field (cash and/or chips), selects the option to convert the balance to new marker check box, and then selects Continue. The supervisor can confirm the balance amount that will be converted to a marker. Since a marker is being issued, the patron can then be asked to enter their PIN (or other identifier) and sign for the Marker. The supervisor will enter their PIN (or other identifier) and sign to authorize the transaction. In some embodiments, the dealer will enter their User ID and sign to confirm the transaction. The transaction is then complete, with the Rim Outstanding Balance reduced to zero and a marker issued to the player

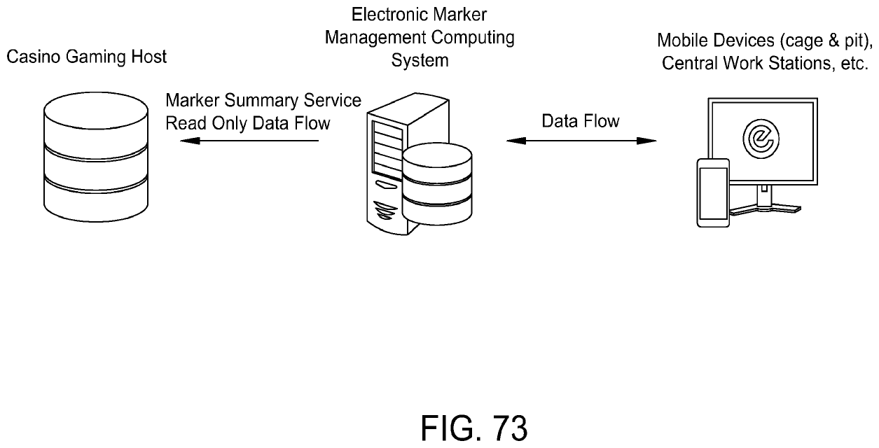

Even though electronic marker management computing systems described herein do not necessarily track actual gameplay, the information gathered about a patron's play is valuable to a casino operator. As schematically shown in FIG. 73, electronic marker management computing systems in accordance with the present disclosure can store, maintain, and log information that can be consumed by one or more player tracking systems of a casino. In accordance with various embodiments, such information can be provided from electronic marker management computing systems via an API. More particularly, an API can allow for a read-only data retrieval from the electronic marker management computing system regarding patron summary information, patron transactions, marker summary data, and so forth. This data can then be used by the operator to, for example, view marker activity and populate master gaming reports. Further, in some embodiments, all data transactions are securely implemented behind a casino firewall.

In accordance with one embodiments, the data retrieved from electronic marker management computing systems can be presented in XML format via a secure webservice. The connection can be initiated on demand or periodically by the casino host system through an API call to the web service that includes proper credentials. As is to be appreciated, the connection can be secured with a restricted IP address and user credentials including username and password, or other suitable techniques. In accordance with some embodiments, the data can be separated into three separate calls, a Patron Summary Information call, a Patron Transactions call, and a Marker summary call. As is to be appreciated, any of a wide variety of API calls can be implemented without departing from the scope of the present disclosure.

The search criteria for a Patron Summary information call can include an Account Number of a patron. In response, in accordance with various embodiments, the webservice can provide Credit Limit, Available Credit, Total Available, Approved Date, Approver User ID, TITO Amount, TTO Approved Date, Front Money Balance, Safekeeping Balance, Cage Marker Amount, Pit Marker Amount, In Transit Amount, Returned Amount, and Write Off Amount, for example.

The search criteria for a Patron Transactions call can include an Account Number, a Transaction Type, and a Date Range. In response, in accordance with various embodiments, the webservice can provide Transaction ID, Transaction Date, Transaction Type, Issue Date, Issued By—User ID, Issue Amount, Issue Location, Status, Paid Date, Paid Amount, Paid Location, Balance on Item, Void Date, Void Approved By—User ID, and Void Reason, for example.

The search criteria for a Marker Summary call can include a Gaming Date and a Shift. In response, in accordance with various embodiments, the webservice can provide Gaming Date, Shift. Game Type, Table Number, Total Issued, Marker Total Void, Marker Total Redeemed for Cash, Marker Total Redeemed for Chips, and Total Rim Redeemed for Chips, for example.

In general, it will be apparent to one of ordinary skill in the art that at least some of the embodiments described herein can be implemented in many different embodiments of software, firmware, and/or hardware. The software and firmware code can be executed by a processor or any other similar computing device. The software code or specialized control hardware that can be used to implement embodiments is not limiting. For example, embodiments described herein can be implemented in computer software using any suitable computer software language type, using, for example, conventional or object-oriented techniques. Such software can be stored on any type of suitable computer-readable medium or media, such as, for example, a magnetic or optical storage medium. The operation and behavior of the embodiments can be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on various types of computer-readable media.

It can also be appreciated that certain portions of the processes described herein can be performed using instructions stored on a computer-readable medium or media that direct a computer system to perform the process steps. A computer-readable medium can include, for example, memory devices such as diskettes, compact discs (CDs), digital versatile discs (DVDs), optical disk drives, or hard disk drives. A computer-readable medium can also include memory storage that is physical, virtual, permanent, temporary, semi-permanent, and/or semi-temporary.

A “computer,” “computer system,” “host,” “server,” or “processor” can be, for example and without limitation, a processor, microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein can include memory for storing certain software modules used in obtaining, processing, and communicating information. It can be appreciated that such memory can be internal or external with respect to operation of the disclosed embodiments.

In various embodiments disclosed herein, a single component can be replaced by multiple components and multiple components can be replaced by a single component to perform a given function or functions. Except where such substitution would not be operative, such substitution is within the intended scope of the embodiments. The computer systems can comprise one or more processors in communication with memory (e.g., RAM or ROM) via one or more data buses. The data buses can carry electrical signals between the processor(s) and the memory. The processor and the memory can comprise electrical circuits that conduct electrical current. Charge states of various components of the circuits, such as solid state transistors of the processor(s) and/or memory circuit(s), can change during operation of the circuits.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope be defined by the claims appended hereto.

We claim:

1. A method of managing an extension of credit request by a patron of a gaming establishment, comprising:
receiving, by an electronic marker management computing system, identifying information about the patron that uniquely identifies the patron and distinguishes the patron from other patrons;
electronically storing, by the electronic marker management computing system, the identifying information;
electronically storing, by the electronic marker management computing system, financial information about the patron, wherein the financial information comprises a credit limit for the patron, an issued marker amount for the patron, and a current extension of credit amount for the patron;
receiving, by the electronic marker management computing system, a request for an extension of credit from the patron for a requested amount of credit extension, wherein the patron is physically located at a first gaming table of the gaming establishment at the time of the request for the extension of credit;
determining, by the electronic marker management computing system, whether to approve the request for the extension of credit based on a comparison of the credit limit for the patron to (i) the issued marker amount for the patron and (ii) the current extension of credit amount for the patron;
when the request for the extension of credit is approved, increasing, by the electronic marker management computing system, the current extension of credit amount for the patron by the requested amount of credit extension;
receiving, by the electronic marker management computing system, a request to convert the requested amount of credit extension to a marker;
increasing, by the electronic marker management computing system, the issued marker amount by the requested amount of credit extension; and
decreasing, by the electronic marker management computing system, the current extension of credit amount for the patron by the requested amount of credit extension.

2. The method of claim 1, wherein the request for the extension of credit is entered into a mobile device positioned proximate to the first gaming table.

3. The method of claim 1, further comprising:
determining, by the electronic marker management computing system, whether the patron is approved for extensions of credit.

4. A method of claim 1 further comprising:
storing, by the electronic marker management computing system, historical information concerning the time and amounts of markers previously approved for the patron; and
storing, by the electronic marker management computing system, historical information concerning the time and amounts of extensions of credit previously approved for the patron.

5. A method of claim 1, wherein the request for an extension of credit is a first request for extension of credit, the method further comprising:
prior to the conversion of any of the requested amount of credit extension to a marker, receiving, by the electronic marker management computing system, a second request for an extension of credit from the patron for a second requested amount of credit extension, wherein the patron is physically located at a second gaming table of the gaming establishment;

6. A method of claim 5, further comprising:
determining, by the electronic marker management computing system, whether to approve the second request for an extension of credit based on a comparison of the credit limit for the patron to (i) the issued marker amount and (ii) the current extension of credit amount, wherein the current extension of credit amount includes the credit amount by the requested amount of first credit extension.

7. A method of claim 6, further comprising:
rejecting, by the electronic marker management computing system; the request for the second extension of credit if extending the second requested amount of credit extension would exceed an available credit amount of the patron.

8. A system of managing an extension of credit request by a patron of a gaming establishment, comprising:
an electronic marker management computing system;
a mobile device positioned proximate to a first gaming table of the gaming establishment, the mobile device in networked communication with the electronic marker management computing system, wherein the mobile device is one of a plurality of mobile devices positioned throughout the gaming establishment;
wherein the electronic marker management computing system is configured to:
receive identifying information about the patron that uniquely identifies the patron and distinguishes the patron from other patrons;
electronically store the identifying information;
electronically store financial information about the patron, wherein the financial information comprises a credit limit for the patron, an issued marker amount for the patron, and a current extension of credit amount for the patron;
receive a request from the mobile device for an extension of credit from the patron for a requested amount of credit extension, wherein the patron is physically located at the first gaming table of the gaming establishment;
determine whether to approve the extension of credit based on a comparison of the credit limit for the patron to (i) the issued marker amount for the patron and (ii) the current extension of credit amount for the patron;
when the request for the extension of credit is approved, increase the current extension of credit amount by the requested amount of credit extension;
receive a request from the mobile device to convert the requested amount of credit extension to a marker;
increase the issued marker amount by the at least some of the requested amount of credit extension;
decrease the current extension of credit amount of for the patron by the requested amount of credit extension.

9. The system of claim 8, further comprising the first gaming table, wherein the gaming table has a dealer chip tray.

10. The system of claim 9, wherein subsequent to approval of the extension of credit, chips from the chip tray are tendered to the patron in the amount of the requested amount of credited extension.

11. The system of claim 8, wherein the gaming establishment comprises a second gaming table, wherein the electronic marker management computing system is configured to:
receive a request from the mobile device for a second extension of credit from the patron for a requested amount of credit extension, wherein the patron is physically located at the second gaming table of the gaming establishment;
determine whether to approve the second extension of credit based on a comparison of the credit limit for the patron to (i) the issued marker amount for the patron and (ii) the current extension of credit amount for the patron, wherein the current extension of credit amount comprises the amount of credit extended at the first gaining table; and
when the request for the second extension of credit is approved, increase the current extension of credit amount by the requested amount of credit extension at the second gaming table.

12. The system of claim 8, further comprising a plurality of gaming tables, wherein the first gaming table is one of the plurality of gaming tables, wherein the mobile device is positioned proximate to each of the plurality of gaming tables.

13. A method of managing an extension of credit request by a patron of a gaming establishment, comprising:
receiving, by an electronic marker management computing system, identifying information about the patron that essentially uniquely identifies the patron and distinguishes the patron from other patrons;
electronically storing, by the electronic marker management computing system, the identifying information;
electronically storing, by the electronic marker management computing system, financial information about the patron, wherein the financial information comprises a credit limit for the patron, an issued marker amount for the patron, and a current extension of credit amount for the patron;
receiving, by the electronic marker management computing system, a request for an extension of credit from the patron for a requested amount of credit extension, wherein the patron is physically located at a first gaming table of the gaming establishment;
determining whether to approve the extension of credit based on a comparison of the credit limit for the patron to (i) the issued marker amount for the patron and (ii) the current extension of credit amount for the patron;
when the request for the extension of credit is approved, increasing, by the electronic marker management computing system, the current extension of credit amount by the requested amount of credit extension;
receiving, by the electronic marker management computing system, an indication of partial repayment of the credit extension by the patron;
receiving, by the electronic marker management computing system, a request to convert an amount of credit extension that is remaining subsequent to the partial repayment of the credit extension to a marker; and increasing, by the electronic marker management computing system, the issued marker amount by the requested amount of credit extension.

14. The method of claim 13, wherein the received indication of partial repayment is based on a repayment transaction by the patron a at the first gaming table.

15. The method of claim 13, wherein the request for the extension of credit is entered into a handheld mobile device positioned proximate to the first gaming table.

16. The method of claim 13, further comprising:
determining, by the electronic marker management computing system, whether the patron is approved for extensions of credit based on an available amount of credit for the patron.

17. The method of claim 13, further comprising:
storing, by the electronic marker management computing system, historical information concerning the time and amounts of markers previously approved for the patron; and
storing, by the electronic marker management computing system, historical information concerning the time and amounts of extensions of credit previously approved for the patron.

18. The method of claim 13, wherein the indication of partial repayment of the credit extension by the patron is based on the tendering of chips to a dealer at the first gaming table by the patron.

19. The method of claim 13, further comprising:
receiving, by the electronic marker management computing system, a plurality of requests for extensions of credit from the patron prior to issuing a marker to the patron.

20. The method of claim 19, further comprising:
receiving, by the electronic marker management computing system, a request to collectively convert each of a plurality of extensions of credit into a single marker.
